(19) United States
(12) Patent Application Publication
(10) Pub. No.: US 2016/0294753 A1
(43) Pub. Date: Oct. 6, 2016

(54) System and Method for Implementing an Integrity-Based Social Network Filtering System and Related Environment

(71) Applicant: Güdly Limited, Dublin (IE)

(72) Inventor: David Centner, Roslyn Heights, NY (US)

(21) Appl. No.: 15/062,720

(22) Filed: Mar. 7, 2016

(30) Foreign Application Priority Data
Apr. 2, 2015 (IE) 2015/0093

(51) Int. Cl. H04L 12/58

(52) U.S. Cl. CPC H04L 51/12; H04L 51/32

(57) ABSTRACT

The disclosed embodiments are directed to a system for facilitating integrity based communications among users of a social network. The system performs operations that include receiving a first message on the social network from a first user that is available to second users of the social network. An indication is transmitted which is displayed on a visual representation associated with the social network and further available to second users of the social network. The indication specifies that the first message is flagged by a third user as non-compliant with a policy of the social network. A first message is transmitted for a review by a first voter selected from a plurality of users of the social network. A first voter is selected based on a predetermined model. The review determines if the first message will be removed from the social networking site. The determined result of the review is transmitted to the first user, indicating whether the first user is restricted from posting the first message for a predetermined period of time. The system also determines if the review by the at least one voter, is ratified based on a quorum of users above a threshold value.

### CROSS-REFERENCE TO RELATED APPLICATION

This non-provisional application claims priority to Irish Patent Application No. 2015/0093, filed on Apr. 2, 2015, which is incorporated herein by reference in its entirety.

### BACKGROUND

1. Technical Field

The present application relates generally to a social network and related system. More specifically, the present application is directed to a system and method of implementing a near real-time integrity based social network environment which includes user-monitored social network behavior.

2. Related Art

Social networks have become widely used mediums of communication. Participants in such networks can include individuals, groups of individuals, and commercial or organizational entities, such as corporations, charitable organizations, or groups of like-minded professionals or enthusiasts. Such social network participants can spend large amounts of time and other resources communicating on such networks. The use of social networks can become habitual. Not only do social networks consume much of people's time, they influence people's behavior when they are offline. Cognizant of this, commercial business entities invest in many resources to use social networks to influence users' behavior. Due to the size and scope of social networks, and the influence they exert on participants, it would be desirable to develop a system and method that quickly and efficiently encourages and awards members within a social network to abide by the guidelines and core values of the social network community.

Social network participants may range in various ages, with greater concern for certain content available to youths of impressionable ages. Communication on social networks can be driven by trends and governed by rules, or the lack thereof, that the participants, or their parents or guardians, do not wish to ascribe to. Participants and parents and/or guardians of participating youths may find the nature of certain information transmitted and available via the social network to be unsuitable.

Accordingly, it is desirable to provide a social network with a technology-based filtering scheme that empowers the participants in the network to ultimately and precisely filter content posted by its users. It is further desirable to accommodate different communities of participants who abide by their own customized rules for social network behavior. Additionally, it is desirable to provide incentives and disincentives for promoting and encouraging the success of the filtering scheme and for promoting positive and appropriate behavior through use of the social network.

Yet it is further desirable to provide a social network filtering system that permits end users to determine what content is considered inappropriate via a flagging system for content that violates the integrity policy set forth by the social networking platform.

Yet it is further desirable to provide a social network filtering system that ensures integrity in the content of the social media content as appropriate to specific audiences. Such a platform would diminish immoral, negative and/or otherwise inappropriate content as deemed by the users of the platform in accordance with the social network's integrity policy.

Yet it is further desirable to provide a social network filtering system that shortens the lifecycle that includes identification of inappropriate content, verification of the content's inappropriateness, removal of said content from the social network, and sanctions against the poster of the content.

Yet it is further desirable that a shortened lifecycle provides for a greatly minimized distribution of inappropriate content, thus lessening the disruptive impact on unsuspecting users from receiving said content.

Yet it is further desirable to provide a social network filtering system that temporarily prevents the distribution of potentially inappropriate content while the content is being reviewed, thus lessening the disruptive impact on unsuspecting users from receiving said content.

Yet is further desirable to provide a user-governed social network filtering system that is a better proxy for the physical world.

Yet is further desirable to provide a user-governed social network filtering system that determines which users are better than others at determining the appropriateness, and therefore are deemed to have good judgment.

Yet it is further desirable to provide a user-governed social network filtering system that content flagged as potentially inappropriate but is ultimately determined to not be inappropriate allows for content to remain on the social network.

Yet it if further desirable to provide a user-governed appeals process within the social network for offending posters to potentially reverse the decision of the user community.

Yet it is further desirable to provide a user-governed filtering system within a social network that will greatly decrease operating expenses of the social network as compared with the labor-intensive review of each post identified as potentially inappropriate.

Yet is it further desirable to provide a user-governed filtering system within a social network because the voice of many users will lead to consistently better results as compared with the judgment of one.

Yet it is further desirable to provide a user-governed filtering system that can accommodate for severe cultural, religious and other differences amongst the user community within the social network.

### SUMMARY

Embodiments of the disclosure will become apparent from the following detailed description considered in conjunction with the accompanying drawings. It is to be understood, however, that the drawings are designed as an illustration only and not as a definition of the limits of this disclosure.

The disclosed embodiments are directed to a system for facilitating integrity based communications among users of a social network. The system includes at least one processing device and a memory to store instructions that, when executed by the processing device, perform operations. The operations include receiving a first message on the social network from a first user that is available to second users of the social network. An indication is transmitted, the indication being displayed on a visual representation associated with the social network, the indication available to second users of the social network and specifying that the first message is flagged by a third user as non-compliant with a policy of the social network. A first message is transmitted for a review by a first voter selected from a plurality of users of the social network. A first voter is selected based on a predetermined model. The review determines if the first message will be removed from the social networking site. A result of the review is transmitted to the first user, wherein the result of the review determining if the first user is restricted from posting the first message for a predetermined period of time. The system also includes determining if the review by the at least one voter is ratified by a quorum of users above a threshold value.

The result of the review may further include determining if the first user is banned from the social network site. A visual representation associated with the network may further include an inner menu of selection items. The visual representation may further include an outer menu of selection items that surrounds the inner menu of selection items. The outer menu of selection items may be subordinate to the inner menu of selection items. The result of the review may further include a decision to reactivate at least one of share, like, and comment features. The result of the review may yet further include the removal of the first message from the social network. The result of the review may yet further include reinstating the first message. The result of the review may yet further include disabling the post from being further flagged. The result of the review may yet further include transmitting a message to the first user of the decision. The decision of the review may yet further include suspending the user for a pre-determined period of time. The decision of the review may yet further include transmitting a banned notification to the first user. The predetermined model may be based on one of a geographical location of users, cluster of online active users in a region nearest the first user, random active users and users with a well-reviewed outcome. The review may yet further include a guard decision by a plurality of voters.

The disclosed embodiments are further directed to a computer-readable device storing instructions that, when executed by a device, cause the device to perform operations that include receiving a first message on the social network from a first user that is available to second users of the social network. An indication is transmitted and displayed on a visual representation associated with the social network. The indication is available to second users of the social network. The indication specifies that the first message is flagged by a third user as non-compliant with a policy of the social network. The first message is transmitted for review by a first voter selected from a plurality of users of the social network. The first voter is selected based on a predetermined model, wherein the review determines if the first message will be removed from the social networking site. A result of the review is transmitted to the first user, wherein the result of the review determining if the first user is restricted from posting the first message for a predetermined period of time. A determination is made if the review by the at least one voter is ratified by a quorum of users above a threshold value.

The disclosed embodiments are further directed a social network including at least one processing device and a memory to store instructions that, when executed by the processing device, perform operations. The operations includes providing a social network to facilitate communication between a plurality of users of the social network operating respective computing devices that are registered for operating to send messages using the social network. The communication includes submitting a message by a first user of the plurality of users for access or receipt by a second user of the plurality of users. The operations also includes registering the respective computing devices to send messages using the social network, including associating an identification number of the respective computing devices with respective registrations of the computing device. The operations further include flagging a message for inappropriate social network behavior. The operations further includes submitting the flagged message for review by at least one arbitrator user selected from the plurality of users for a determination of inappropriateness of the message. The operations further include applying restrictions to participation by the first user in the social network in response to a determination associated with the review by the at least one arbitrator that the message is inappropriate.

The operations may further include applying the restrictions which includes displaying an indicator associated with a displayed profile associated with the first user when the first user participates in the social network, the indicator indicating that a penalty was determined for the first user. The penalty may be selected from one of probation for a selected time period, suspension of participation in the social network for a selected time period, and expulsion from the social network. The suspension and expulsion may further include blocking access to the social network by the first user's computing device based on the identification number associated with the registration of the computing device.

The disclosed embodiments may further include a social network comprising at least one processing device and a memory to store instructions that, when executed by the processing device perform operations. The operations include providing a social network to facilitate communication between a plurality of users of the social network operating respective computing devices to send messages using the social network, in which a message is communicated by a first user of the plurality of users for access or receipt by a second user of the plurality of users. The operations further include flagging a message for demonstrating positive social network behavior. The operations further include submitting the flagged message for a determination that the message demonstrates positive social network behavior. The operations further include rewarding the first user by awarding points to the first user in response to a determination that the message demonstrates positive social network behavior. The operations further include receiving a schedule of points and deeds from a device of a sponsor participant in the social network that describes a payment scheme relating at least one deed to a value of points. The operations further include receiving from the first user a payment of points having a value in exchange for a commitment by the sponsor participant to perform a deed that is related to the value in accordance with the schedule of points and deeds.

The present application is applicable to a web server of a computerized social network. The web server includes at least one processing device and a memory to store instructions that, when executed by the processing device perform operations. The operations include providing a social network to facilitate communication between a plurality of users of the social network operating respective computing devices in which a message is communicated by a first user of the plurality of users for access or receipt by a second user of the plurality of users. The operations further include flagging a message for demonstrating positive or inappropriate social network behavior. When flagged for inappropriateness, the operations further include submitting the message for review by at least one arbitrator user selected from the plurality of users for a determination of inappropriateness of the message. When flagged for positive social network behavior, the operations for include submitting the flagged message for a determination that the message demonstrates positive social network behavior.

In response to a determination that the message demonstrates positive social network behavior, the operations further include rewarding the first user by awarding points to the first user; receiving a schedule of points and deeds from a device of a sponsor participant in the social network that describes a payment scheme relating at least one deed to a value of points; and transacting a transaction, including receiving from the first user, when awarded points, a payment of points having a value in exchange for a commitment by the sponsor participant to perform a deed that is related to the value in accordance with the schedule of points and deeds.

Embodiments of the disclosure will become apparent from the following detailed description considered in conjunction with the accompanying drawings. It is to be understood, however, that the drawings are designed as an illustration only and not as a definition of the limits of this disclosure.

### BRIEF DESCRIPTION OF THE DRAWINGS

The drawings constitute a part of this disclosure and include examples, which may be implemented in various forms. It is to be understood that in some instances, various aspects of the disclosure may be shown exaggerated or enlarged to facilitate understanding. The teaching of the disclosure can be readily understood by considering the following detailed description in conjunction with the accompanying drawings.

FIG. 1 illustrates a system block diagram of an exemplary social network system;

FIG. 1(a) illustrates a block diagram of an exemplary computing device that implements the social networking platform.

FIG. 1(b) illustrates an example of a system environment that implements the social networking platform.

FIG. 2 illustrates a block diagram of modules in an exemplary social network system of FIG. 1;

FIG. 3 illustrates a flow chart illustration of an example method of determining a non-compliant message posted on the social networking site of FIG. 1;

FIG. 4 is a flowchart that illustrates an example method of monitoring content in accordance with the social network system of FIG. 1;

FIG. 5 is a flowchart which illustrates an example method of the flagging and voting process, in accordance with the social network system of FIG. 1;

FIG. 6(a) is an example menu implemented in connection with the flagging and voting process of FIG. 5;

FIG. 6(b) is an example menu implemented in connection with the flagging and voting process of FIG. 5;

FIG. 6(c) is an example menu implemented in connection with the flagging and voting process of FIG. 5;

FIG. 6(d) is a sub-menu of items implemented in connection with the flagging and voting process of FIGS. 6(a)-6(c);

FIG. 6(e) is an example selection from a sub-menu of items of FIG. 6(b);

FIG. 6(f) is an example selection from a sub-menu of items of FIG. 6(b);

FIG. 6(g) is an example selection from a sub-menu of items of FIG. 6;

FIG. 7 is a flowchart of an example method of flagging content;

FIG. 8 is a flowchart of an example method of review of flagged content and the decision process;

FIG. 9 is a flowchart of an example method of monitoring wrongful flagging;

FIG. 10 is an illustration of fixed size geographic location model for identifying a reviewing team;

FIG. 11 is an illustration of variable size geographic location model for identifying a reviewing team;

FIG. 12 is an illustration of nearest active users model for identifying a reviewing team;

FIG. 13 is an illustration of random active users model for identifying a reviewing team;

FIG. 14 is an exemplary embodiment of the flagging process;

FIG. 15 is an exemplary embodiment of the flagging engine;

FIG. 15(a) illustrates an embodiment of the process as implemented by flag guard generator as described in connection with FIG. 15;

FIG. 15(b) illustrates an embodiment of the flag voting listener process as described in connection with FIG. 15; and

FIG. 16 is a block diagram showing a portion of an exemplary device in the form of a computing system that performs methods according to one or more embodiments.

Embodiments of the disclosure will become apparent from the following detailed description considered in conjunction with the accompanying drawings. It is to be understood, however, that the drawings are designed as an illustration only and not as a definition of the limits of this disclosure. It is to be appreciated that elements in the figures are illustrated for simplicity and clarity. Common but well-understood elements, which may be useful or necessary in a commercially feasible embodiment, are not necessarily shown in order to facilitate a less hindered view of the illustrated embodiments.

### DETAILED DESCRIPTION

Typical web or mobile-based social networks aim to manage and curtail objectionable behavior and thus filter the content available on the network. Various approaches—manual and automated—have been attempted, yet all fall short of the lofty goal of a social network free of inappropriate content, at least as deemed as such to a majority of participants or to a majority of a certain group of participants having some commonality (example, age, interests, profession, etc.). As a result, social networks of today are littered with so-called “trolls”, “haters” and/or “flamers”, with little consequence for the poster of such questionably inappropriate content. And worse yet, these posts sometimes result in serious emotional or physical harm to the victim. Automated tools, such as those that monitor certain words, terms, or image recognition, can only go so far, and artificial intelligence has not progressed to the point where machines can identify inappropriate content within the subtle context of user discussion. Methods, such as those that monitor for certain words and terms in content, may not be effective, at understanding more subtle content that may be inappropriate to certain ranges of users, but not all. In addition, content may be too complex to classify as inappropriate since such content may require in-depth knowledge of the customary practices and boundaries of a certain community of users. And where automation ends, manual review takes over, which may be subjective, slow and sporadic in response, and expensive in implementation. These systems rely on users reporting inappropriate content to a system employee whereupon the community must rely on the judgment of a single individual, said individual who may not be familiar with the social norms of the social network. And worse yet, this review of the potentially inappropriate content may take days or hours, which subjects all other users to the inappropriate content until the system operator takes action. Indeed, with the lengthy delay in current system's review process and the absence of any real consequences for the posting of inappropriate content has created a titillating environment replete with trolls, haters, and flamers. Other methods curtail objectionable behavior by mere reliance on a type of action by a particular user and any related history without further assessment as to the corrective action required thereby ensuring a social networking environment that is integrity-based to all or at least a majority of users.

Therefore, it would be desirable to implement a computer-based system and method which curtails inappropriate social network behavior by empowering users to quickly ascertain the integrity appropriateness of select content, implement an arbitration system to more fairly assess each instance of allegedly inappropriate content, remove said content from the system, sanction with real consequences the original poster of the inappropriate content, reward the community members who were involved in the identification and validation of the appropriateness (or lack thereof) of the questionable content, all the while accommodating for cultural, religious and other differences among the social network's user community. Ideally the aforementioned computer- and user-based events and benefits transpire within a short time frame, perhaps 1 minute or less, thus minimizing disruption to other users of the social network community. In short, such an invention would provide for a superior system than currently exists.

Therefore, it is desirable to implement a system and method of monitoring social network behavior and for promoting socially beneficial activity as disclosed herein. In the following description, for the purposes of explanation, numerous specific details are set forth in order to provide a thorough understanding of example embodiments or aspects. It will be evident, however, to one skilled in the art, that an example embodiment may be practiced without all of the disclosed specific details.

A computerized social network is provided in which a user's activity can be flagged, such as by a peer or an administrator. A flagged activity can be distributed for review to a jury of arbitrators who are peers in the social network. A user's activity on the social network can be restricted due to an inappropriate behavior. The restriction can include suspending or expelling the user from the social network. The restriction can be implemented by blocking access to the social network via the user's hardware device, such as a smart phone, router, or computer. An identifier that identifies the hardware device can be associated with the user's account and used to block the device from accessing the user network, making it difficult for a user to circumvent the restriction by changing accounts.

The social network further encourages and reinforces positive behavior. When a user performs a socially beneficial activity, such as by sending a positive message to a peer, or posting positive information for others to access, the user can be rewarded with points. A message can be flagged as demonstrating positive social network behavior by a peer (e.g., the recipient of the message) and/or an administrator. A determination is made whether or not the message demonstrates positive network behavior. The determination can be made by one or administrators or by a jury of arbitrators that are peers in the social network. Charitable sponsors can pledge to make donations in honor of a user in exchange for points redeemed by the user. For example, a first sponsor can pledge to donate $100 to a children's hospital in exchange for 100 points. A second sponsor can pledge to plant a tree in exchange for 50 points. A user can browse through a variety of charitable sponsors and their pledged donations a make a selection with which to redeem earned points. If the user selects the second sponsor, the user can pay 50 of the user's accumulated points in exchange for the second sponsor to plant the tree in the user's honor. In this way positive actions by individuals on the social network results in tangible benefits to society.

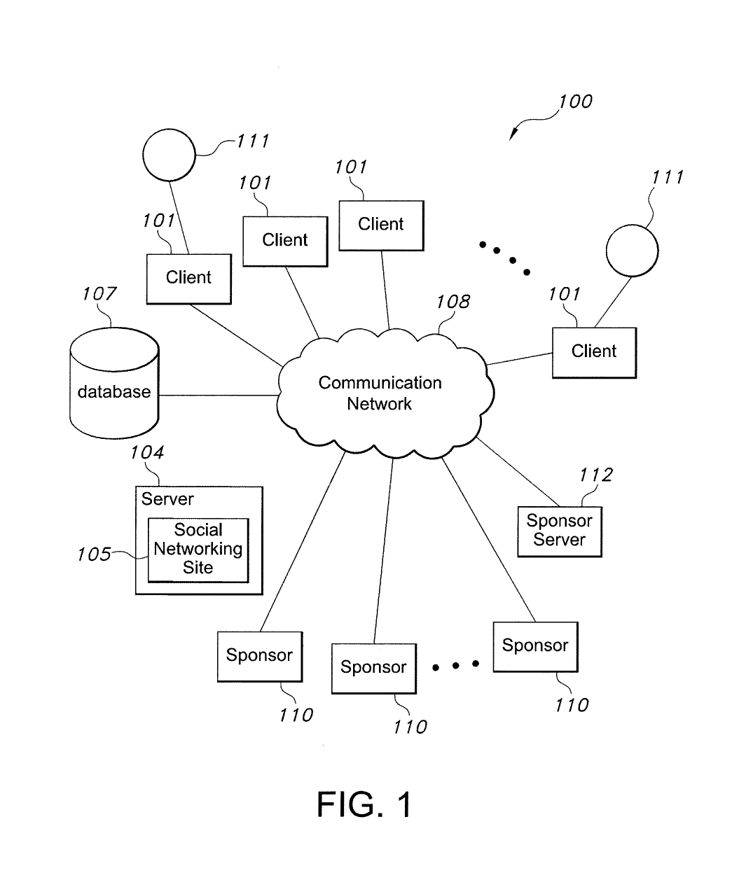

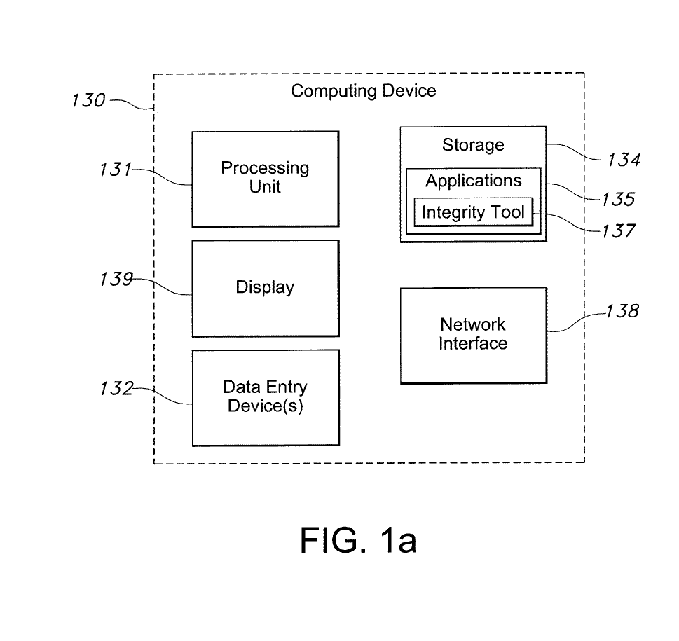

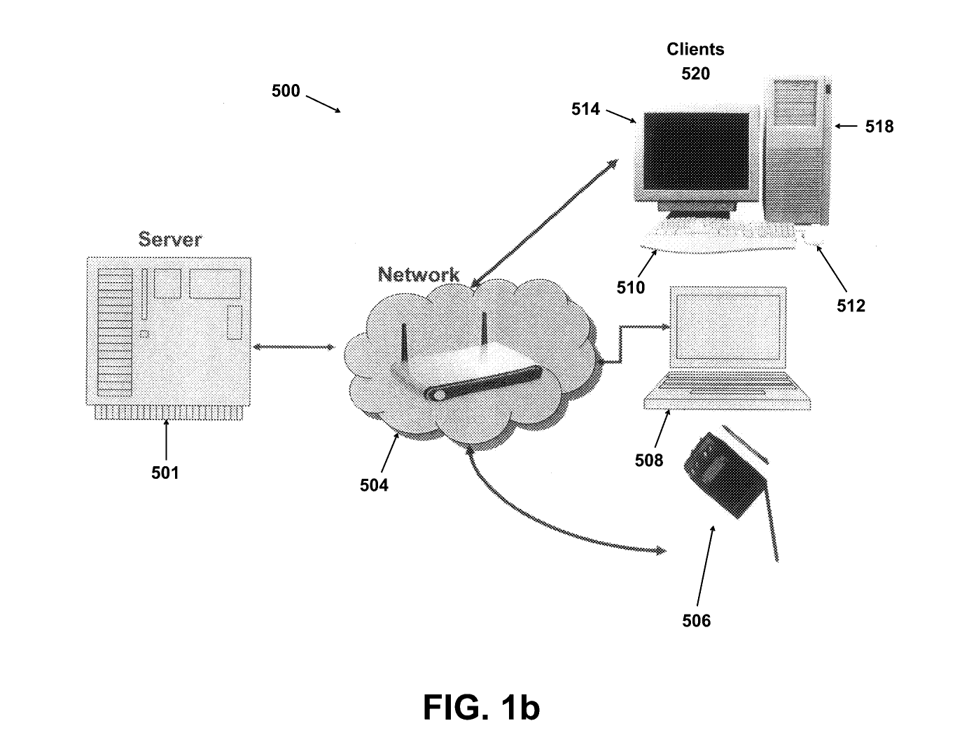

FIG. 1 illustrates an example social network system 100. The example system 100 provides interactive monitoring of one or more communities, e.g., social groups, within a social network established by the social network system 100. Each community can establish customized rules for acceptable social network behavior. Additionally, the example social network system 100 provides incentives to participants for complying with or enforcing the rules for acceptable social network behavior. The social network system 100 further provides incentives for using the social network system 100 to perform positive acts.

The example system 100 includes a plurality of computing devices 101, at least one social network server 104, at least one server database 107, and a communication network 108. The communication network 108 enables communication among the computing devices 101, social network server 104, database 107, and optionally one or more sponsors 110, and a sponsor server 112.

In certain embodiments, the computing system 100 includes a server device 104 that may be coupled to client computing devices 101 (hereinafter client(s)) using a communication network 108. The network 108 can be any network over which information can be transmitted between such devices that are connected to the network. For example, the communication network 108 can be implemented by the Internet, intranet, Virtual Private Network (VPN), Local Area Network (LAN), Wide Area Network (WAN), Bluetooth, and other similar network structures. The server 104 and client device(s) 101 can be implemented using computing devices as further described for example in FIG. 1a.

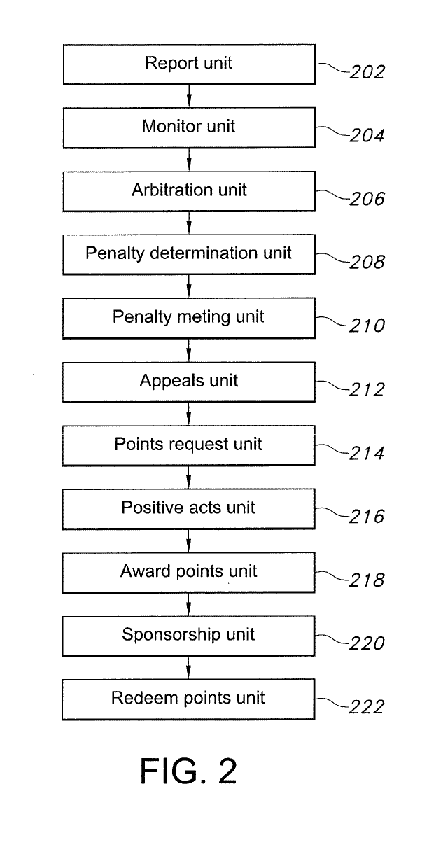

The server 104 can be further configured to provide a platform for a social networking environment to client(s) 101. The server 104 in certain embodiments can be associated with a web server which provides a particular online social networking website 105 that ensures integrity based communications among client(s) using for example, various integrity based modules as described in connection with FIG. 2 hereinbelow. Users of the social networking platform can establish communications and/or connections with other users of the social networking platform. A user that is connected to each other via single hop (for example, directly connected using the friends feature of Facebook®) may be referred to as neighbors. The server 104 is equipped to maintain all user information and connections with other users of the social networking site 105 as well as information that users post (among other features that ensure the integrity based communications of the disclosed embodiments). In certain embodiments, the integrity based social networking site 105 hosted on the network 100 may be further configured to cooperatively link to features of Facebook, Twitter, LinkedIn, Plaxo, MySpace and similar social networking sites.

The client computing devices 101 can each include, for example, a personal computer (e.g., desktop or laptop), tablet computing device, a smart phone, a smart device, or a computer terminal of a network of computing devices. A user 111 of the client computing device 101 is also shown. In a preferred embodiment, the user 111 communicates with the social networking site 105 using client computing devices 101. The client computing device 101 can communicate with other devices via the communication network 108, including other computing devices 101 and the social network server 104. The communication can be wired, wireless (e.g., Wi-Fi, cellular, Bluetooth, etc.), or a combination thereof. The computing device 101 can receive, store, and/or execute a web browser or app screen for accessing and exchanging information with the social network server 104 and other computing devices 101 via the Internet (e.g., communication network 108).

Client device(s) 101 can be configured to be communicatively coupled to the server 104 by executing applications which interface with the server 104, transmit or receive information from the server 104. In certain embodiments, clients 101 may be further configured to implement a web browser which interfaces with the server 104 in order to allow a user 111 to retrieve, view and post information on the social network that is compliant with the integrity based social networking site. Alternatively the client may interface with the server with a mobile smartphone device or other network-connected client. Client(s) 101 may interact with other users of the social network and/or interact with other users of the social networking site 105 with whom such user(s) may be connected to either via the disclosed integrity based social networking site, and in other embodiments via other social networking sites. Client(s) 101 may be implemented in certain embodiments, for example by a personal computer (PC), laptop computer, workstation, handheld device, a personal digital assistant (PDA), smart phone and/or similar devices.

The computing device(s) 101 may include at least one storage device and at least one processing device that performs operations, in accordance with execution of instructions, for connecting to and participating in a social network provided by the social network system 100. The instructions can be included in a device social network module (the “device unit”) provided, for example, by the web browser and/or a mobile application (eg., application or “App”). The computing device 101 has a display device screen that can present a graphical user interface (GUI) to display information to the user and provide fields that can be used to input information to the client computing device 101. Information can be input using a user input device of the computing device 101, such as a touch screen, a cursor control device (e.g., a mouse, touchpad, or joystick), a keypad, or keyboard. The web browser or “App” can be downloaded and stored by the client computing device 101. When the web browser or application is executed, the client computing device 101 can exchange information with the social network server 104 for connecting to and participating in the social network. The web browser or application generates a GUI that the user 111 of the computing device 101 can use to interact with the social network server 104 for exchanging information.

As described, the social network server 104 can include one or more computers, such as a network server or a web server, that process requests and deliver data to the computing devices 101, e.g., in accordance with a server/client relationship via communication network 110. Moreover, social network server 104 can communicate with the computing devices 101 and their device units via the communication network 108, such as by providing a web page or app screen to a computing device 101 and using these to exchange information.

The social network server 104 includes at least one storage device and at least one processing device that performs operations, in accordance with execution of instructions, for implementing the social network system 100, including enabling computing devices 101 to connect to and participate in the social network for communicating (e.g., sending or posting messages) with the server 104 and other computing devices 101. The instructions can be included in a social network server unit.

The social network database 107 can include one or more databases stored on one or more storage devices that can be accessed by the social network server 104. The social network database 107 can store information about, for example, users, communities of users, and sponsors. A profile can be stored for each user 111 that includes information, such as identification and demographic information about the user 111, identification of the user's computing device(s) 101 that the user 111 accesses the social network with, preferences related to participation in the social network that the user 111 has selected, communities that the user 111 has joined as a member, and history information about the user's 111 participation in the social network. The history information can include, for example, dates and related events, such as reports generated by the user 111, reports about messages sent by the user 111 alleging noncompliance with rules, penalties determined for the user 111, participation in arbitration procedures as a monitor and/or arbitrator, point requests submitted by the user 111, and accounting information, such as points awarded to the user 111 and points redeemed by the user 111. The user's identification information can include, for example, a user ID and password or biometric data. The computing device 101's ID can be an identification code that is always associated with the computing device 101 or its network connection. For example, the computing device 101's ID can be an International Mobile Equipment Identity (IMEI), a Mobile Equipment ID (MEID), or an IP address. The communication network 108 can include one or more of long haul transport network (e.g., gigabit Ethernet network, Asynchronous Transfer Mode (ATM) network, frame relay network), wireless network (e.g., satellite network, Wi-Fi network, cellular network, or another wireless network), other public or private networks, or any combination thereof. The foregoing is not exhaustive and alternate or additional communication networks can be employed to interconnect the computing devices 101, social network server 104, database 107, and sponsor servers 110.

The communication network 108 can include one or more of a wide area network (WAN), local area network (LAN), virtual private network (VPN), peer-to-peer (P2P) network, as well as any other public or private network, or any combination thereof. Other conventional or yet to be developed communication networks can form at least a part of the communication network 108. At least a portion of the transmission over the communication network 108 can be accomplished, for example, via Transfer Control Protocol/Internet Protocol (TCP/IP), User Datagram Protocol (UDP)/IP, or any combination of conventional protocols or yet to be developed protocols.

The sponsors 110 can implement functions using a computing device, such as a personal computer (e.g., desktop or laptop), tablet computing device, a smart phone, a smart device, or a computer terminal of a network of computing devices, etc. The sponsor device 110 can communicate with other devices via the communication network 108, including other computing devices 101, the social network server 104, and the sponsor server 112. The communication can be wired, wireless (e.g., Wi-Fi, cellular, Bluetooth, etc.), or a combination thereof. The sponsor device 110 can receive, store, and/or execute a web browser or app screen for accessing and exchanging information with the social network server 104 and/or the sponsor server 112 and other devices via the Internet (e.g., communication network 108).

The sponsor device 110 includes at least one storage device and at least one processing device that performs operations, in accordance with execution of instructions, for connecting to and participating in the social network as a sponsor. The instructions can be included in a sponsor social network module (the “sponsor unit”) provided, for example, by the web browser and/or a mobile application. The sponsor device 110 has a display device screen that can present a graphical user interface (GUI) to display information to the user 111, and can further be used to receive input information from the sponsor device 110. Information can be input using a user input device of the sponsor device 110, such as a touch screen, a cursor control device (e.g., a mouse, touchpad, or joystick), a keypad, or keyboard. The web browser or “app,” can be downloaded and stored by the sponsor device 110. When the web browser or application is executed, the sponsor device 110 can exchange information with the social network server 104 or sponsor server 112 for connecting to and participating in the social network as a sponsor. The web browser or application can generate the GUI that the user 111 of the sponsor device 110 can use to interact with the social network server 104 or sponsor social network server 104 for exchanging information.

The sponsor server 112 can include one or more computers, such as a network server or a web server, that can include one or more computers, such as a network server or a web server, that process requests and deliver data to the sponsor devices 110, e.g., in accordance with a server/client relationship via communication network 108. Moreover, sponsor server 112 can communicate with the sponsor devices 110 and their sponsor units via the communication network 108, such as by providing a web page or app screen to a requesting sponsor devices 110 and using these to exchange information.

The sponsor server 112 includes at least one storage device and at least one processing device that perform operations, in accordance with execution of instructions, for implementing the social network system 100, including enabling sponsor devices 110 to connect to and participate in the social network. The instructions can be included in a sponsor server social network module (the “sponsor server unit”).

The computing devices 101 can be operated by users 111. The users 111 can operate their computing devices 101 to connect to and participate in the social network. The users 111 can join or form communities within the social network. The communities can be mutually exclusive, overlap one another, or be nested within one another. Each community can have associated rules for social network behavior within the community. In an embodiment, every user 111 that joins the social network is by default a member of the default community that encompasses all users 111, and must abide by a default set of rules established for the default community. A user 111 can be a member of more than one community. An example community is shown that includes the users 111 within the shown circle. Users outside of the dedicated circle are not members of the community.

In an embodiment, the server 104 facilitates the social network and at least one community within the social network. Facilitation of the social network includes providing GUI's to participating users' computing devices 101 (e.g., via web browsers or apps), and transmitting or posting messages for intended recipients to receive or have access to. Each message is sent and accessible in accordance with community membership of the user 111 that sent or posted the message and the user(s) receiving and accessing the message.

Users 111 can communicate with one another by sending or posting messages. Messages can include content such as text, graphics, photographs, audio recordings, videos, or links to content. A message that is “sent” is sent from a sender user 111 in order to be received by one or more users 111. A message that is “posted” by a poster user 111 and can be accessed by a user 111 that has permission to access the posting. Permission to access the message can be determined by profiles associated with the user 111 that posted the message and/or the user 111 that seeks to access it, including the communities to which they belong.

A message can be designated for a particular community to restrict the intended receivers and users 111 that can access the message to members of the designated community. Additionally, a community can restrict messages designating the community to messages that were sent or posted by users 111 that are members of the community. In the absence of a community designation, a default community designation is used. The user 111 that sent or posted the message may have designated a default community designation. If not, the default community is the community of all users 111 in the social network. Users 111 within a community can expect all messages designating their community to comply with the community's rules for social network behavior. A user 111 that receives or accesses a noncompliant message can report it using a reporting capability provided by the social network server 104. A noncompliant message refers to a message that is inappropriate, e.g., does not comply with the rules of the community that it was communicated within.

In another embodiment, the social network system 100 can be a distributed network or a peer-to-peer network that does not include a server 104, or wherein the server 104 has a limited capacity, such as providing and/or updating software for implementing the social network. Once the software is downloaded and stored, the computer devices 101 can execute the software for connecting to and/or participating in the social network without the intervention of the server 104. Additionally, the peers can obtain software to download from other peers.

FIG. 1a is a block diagram of an exemplary computing device that implements one or more embodiments of the social networking platform. The computing device 130 in some embodiments can be configured to implement certain embodiments of the social networking integrity tool 137 which ensures integrity of content and the overall environment of the social networking platform and related site 105. The integrity tool 137 can in certain embodiments comprise modules as shown in FIG. 2 as associated with one or more embodiments of the social networking platform described in greater detail below. The computing device 130 can be a mainframe, personal computer (PC), laptop computer, workstation, handheld device, such as a PDA and/or smart phone, and similar devices including futuristic devices which can perform similar functions more efficiently and/or include yet additional futuristic functions. The computing device 130 can be integrated with the server 104 and/or coupled to the server 104 such that communications or information can be exchanged. The computing device 130 may include one or more processing units 131, such as a central processing unit (CPU) and/or graphical processing units (GPUs) and may include storage 134. In some embodiments, the computing device 130 may further be coupled to a display device 139 and/or data entry device (s) 132, such as a keyboard, touch screen and/or mouse including similar entry devices whether known or futuristic. The storage 134 may store data and instructions that can be implemented using one or more computer readable medium or memory technologies, such as a floppy drive, hard drive, tape drive, Flash drive, optical drive read only memory (ROM), random access memory (RAM), and the like. Applications 135 or similarly, Apps, such as the Integrity tool 137, and/or portions thereof, can reside in the storage 134 or memory device. The instructions may include instructions for implementing embodiments of the Integrity tool 137. The one or more processing units 131 may execute the applications 135, such as the integrity tool 137, in the storage 134 by executing instructions stored therein and storing data resulting from the executing instructions. The storage 134 may be local or remote from the computing device 130. The computing device 130 may include a network interface 138 contemplated for communicating with a network such as the integrity based social network 100 as shown in FIG. 1.

FIG. 1(b) is an example system environment 500 in which the disclosed methods of the social media network may be implemented. A server 501 is connected using a network 504 to various user clients 502. The server 501 may be implemented using any computer such as a personal computing device to a supercomputer configured with any secondary and/or additional storage including but not limited to tape, disk, SAN storage system. The server 501 may support fault tolerance including but not limited to RAID, component mirroring, and/or various voting schemes. The network 504 may support many known protocols in the art including but not limited to IP, Internet, WAN, LAN, cellular or other ad hoc network using cable, fiber, satellite or wireless technology.

Clients 520 connected to the network 504 may include workstations 518, personal computers, 508, personal digital assistants (PDA) 506, personal communication devices such as mobile telephones or devices communicating using wireless technology or mobile devices having combinations of PDA and communications devices. Clients 520 may be configured with one or more processors that may include specific integrated circuits (ASICs), local memory, input devices such as keyboard 510, touch-screen display, hand-writing device with hand-writing recognition software, mouse 512, and/or microphone. Output devices may include a monitor 514, printer or speaker. Communication devices such as a modem, WIFI card or other network interface such as a network interface card (NIC). FIG. 2 shows modules 202-222, e.g., software programs or functional modules, that are stored by at least one storage device and include instructions that when executed by a computing device for example, cause at least one processor to perform operations. The modules include a report module 202, a monitor module 204, an arbitrator module 206, a penalty determination module 208, a penalty meting module 210, an appeals module 212, a request awards module 214, a positive acts module 216, an award points module 218, a sponsorship module 220, and a redeem points module 222. The units 202-222, when executed, cause at least one processing device of the social network system 100 to perform operations to perform the functions described throughout the application.

The social network server 104 can provide units 202-222, or portions thereof, to computing devices 101 that are participating in the social network system 100, e.g., as apps or webpages. Accordingly, the functionality of the social network system 100 can be distributed amongst the social network server 104 and the computing devices 104. In this way, the social network server 104 can facilitate the functionality of units 202-222, by either providing a portion or all of one or more of the units 202-222 to one or more computing devices 101 to perform a portion or all of the function of the units 202-222. Additionally, the social network server 104 can facilitate the functionality of units 202-222 by executing one or more of the units 202-222 or portions thereof. The units 202-222 provide the functionality described below, including GUI(s) for exchanging information between the computing devices 101, the social network server 104, the sponsor server 112, the sponsors 110 and processing the information exchanged. Alternatively, e.g., in a peer-to-peer network, the units 202-222 can be executed by one or more processing devices of peer processing devices of the social network system 100.

The report module 202, which facilitates reporting an inappropriate message, can be stored and executed by computing devices 101 of reporter-users that have reporting privileges. A reporter-user can be a user 111 of a computing device 101 that executes the report module 202 or an administrator of the social network server 104. Reporting privileges can be determined by the administrators of the social network or by individual communities. In one embodiment, all users 111 are awarded reporting privileges, but these may be repealed when abused, or when the user 111 has been the subject of reports for improper communication, e.g., sending or posting a noncompliant message. In another embodiment, reporting privileges are earned, such as by proper qualifications, peer suggestions, earning points, and using proper social network behavior for a prescribed time period.

The report module 202 generates a GUI that provides a report entry screen via which a reporter-user can flag a message as being inappropriate or for demonstrating positive social network behavior. The message can be flagged, for example, when the reporter-user submits a report regarding a message for being inappropriate on the basis of noncompliance with governing rules or for being offensive. The message can also be flagged when the reporter-user submits a report reporting the message for demonstrating positive social network behavior based on a predetermined set of rules or based on the reporter-user's belief and recognition of the positive aspect of the behavior.

The GUI can include fields for the reporter-user to enter information for the report and a user-interface element, such as a submit button, that the report-user can actuate to submit the report. For example, a received message can be provided with more than one reply or report button. Reply or Report button can be labelled “Reply and report as inappropriate,” “Reply and report as positive,” “Report,” and “Reply.” Based on the reply or report button selected, the reporter-user can select whether to only reply, only report, or to reply with a report for appropriateness or positive social network behavior. Upon selecting a button that includes reporting the message, a GUI is provided for the report-user to enter and submit a report.

The report can include the identification of the reporter-user, the identification of the user 111 that generated the noncompliant message or performed the award-winning social network behavior, the noncompliant message, evidence of the award-winning social network behavior (e.g., a message from or about the sender-user transmitted or posted within, or external to, the social network), identification of the rule that was allegedly not complied with and the community the rule is associated with, and identification of the award-winning behavior.

The report can further include an explanation why the message does not comply with the rule(s). The report can include any background information that the reporter-user has knowledge of or chooses to share. The report can include an indicator (e.g., a link or a URL address) of how or where to access the content of the report or for any of the items included in the report. The information provided in the report can include data that can be automatically processed by a processing device (such as quantitative data) and/or data that may need to be processed with user intervention (such as free text). Quantitative information includes, for example, binary information, such as yes/no; numeric data, such as ratings or scores (e.g., rating degree of noncompliance based on a scale, e.g., 1-5); or menus selections.

The report module 202 can further request from the award points module 218 that points be awarded to the reporter-user for reporting noncompliant messages. Once a report is generated, the report can be reviewed by one or more peers and/or administrators. For example, the monitor module 204 can be executed to select and monitor a jury of peers (arbitrators) to arbitrate the reported message. The arbitration module 206 can be executed to facilitate arbitration by the arbitrators and generate a determination about the the flagged message of inappropriateness of the message or positive social network behavior.

A message or activity can also be flagged for positive social network behavior by the points request module 214 or the positive acts module 216. The award points module 218 can determine how many points to award, if any, for a message or activity that was flagged. Additionally, if a report about a flagged message was submitted for arbitration, the arbitration outcome generated by the arbitration module can be submitted to the award points module 218 for a determination of how many points to award, if any.

Awarded points can be redeemed by displaying an indicator associated with a persona associated with the sender-user or awardee in connection with participation in the social network. Additionally, or alternatively, the points can be redeemed by the redeem points module 222 in exchange for good will gestures and acts by a sponsor entity. The sponsorship module 220 can receive from a sponsor 110 a schedule of points and deeds that describes a payment schedule that relates at least one deed to a value of points. The redeem points module 222 can transact a transaction, including receiving from the sender-user or the awardee a payment of points having a value in exchange for a commitment by the sponsor entity to participant to perform a deed that is related to the value in accordance with the schedule of points and deeds. While the social network encourages positive acts using the social network, by rewarding them, the social network further discourages inappropriate behavior by empowering, users of the social network empowered to report inappropriate behavior. Accordingly, if a user engages in activity that falls outside the accepted norms for the social network, such behavior can be addressed to maintain the integrity of the social network. For example, if a user engages in inappropriate language or transmits inappropriate pictures, that behavior can be flagged and curtailed. In accordance with aspect of the disclosure, the social network includes an arbitration system which reviews questionable behavior and takes appropriate action to stop it from occurring in the future.

When a determination is made that the message was inappropriate, e.g., based on the arbitration outcome generated by the arbitration module 206, the penalty determination module 208 determines which penalty to mete out. The determined penalty can be a warning or an application of restrictions to the sending-user's participation in the social network system 100. The penalty meting module 210 oversees meting out the penalty. Units 204-222 are described below in greater in detail.

The monitor module 204, which facilitates selecting and monitoring a panel of arbitrators, can be stored and executed by computing devices 101 of a monitor-user and/or by social network server 104. A monitor-user can be a client user 101 or an administrator of the social network server 104 that has monitoring privileges and operates a computing device 101 that executes the monitor module 204. Monitoring privileges can be determined by the administrators of the social network or by individual communities. In one embodiment, all users 101 are awarded monitoring privileges, but these may be repealed when abused, or when the user 111 has been the subject of reports for improper communication. In another embodiment, monitoring privileges are earned, such as by proper qualifications, peer suggestions, earning points, and using proper social network behavior for a prescribed time period.

The monitor module 204 receives a report submitted by a reporter-user. The monitor module 204 selects arbitrators to join an arbitration procedure to arbitrate the reported noncompliant message (or award-winning behavior), as well as determine if the report was warranted, and whether or not, and to what degree, the rules were infracted. The monitor module 204 can generate a GUI to be displayed by a display device of the computing device 101 or social network server 104 which may host the social networking site 105 executing the monitor module 204. The GUI provides a monitor entry screen that the monitor-user can use to enter and submit arbitration requests to arbitrators for soliciting them to join the current arbitration procedure, communicate with the arbitrators, and monitor the arbitrators.

The arbitration requests can include the information that was included with the report, which can be further edited (automatically or by a user) for correctness or automatic processing. The arbitration request can include a history of previous penalties levied on the sender-user or the report-user for previously submitted unwarranted reports. This information can be in a quantitative form, such as for automatic processing or uniform processing by different arbitration-users. The arbitration request can include an indicator (e.g., a link or a URL address) of how or where to access the content of the arbitration request, the report and/or any items included therein. Access to information included in the arbitration request or the report can be controlled in accordance with authorization of the arbitrator accessing the information. The monitor module 204 can further evaluate arbitration-users for properly responding to the arbitration requests. Additionally, the monitor module 204 can request from the award points module 218 that points be awarded to the arbitration-users.

The arbitrator module 206, which allows arbitrators to participate in the arbitration procedure, can be stored and executed by computing devices 101 of arbitrators that have arbitrating privileges. An arbitrator can be a user of a computing device 101 or an administrator of the social network server 104 and operates a computing device 101 that executes the arbitrator module 206. Arbitrating privileges can be determined by the administrators of the social network or by individual communities. In one embodiment, all users are awarded arbitrating privileges, but these may be repealed, such as when they are abused, or when the user has been the subject of reports for improper communication. In another embodiment, arbitrating privileges are earned, such as by proper qualifications, peer suggestions, earning points, and using proper social network behavior for a prescribed time period. Additionally, in order for a user to be an arbitrator, the computing device 101 operated by the arbitrator must be capable of executing the arbitrator module 206, such as by downloading and installing it or accessing it via an app or a webpage.

The arbitrator module 206 receives a request from a monitor module 204 to join an arbitration procedure. The arbitrator module 206 can generate a GUI to be displayed by a display device of the computing device 101 or the social network server 104 executing the arbitrator module 206. The GUI provides an arbitration screen via which the arbitrator operating the computing device 101 or the social network server 104 can view the request and generate an arbitration report in reply to the arbitration request.

Arbitration information included in the report can be quantitative data that can be automatically processed. For example, the arbitration information can include a YES/NO determination for infraction of each applicable rule of social network behavior, a rating for each rule, or a single arbitration score for a set of rules (e.g., in accordance with a predetermined rating system). Additionally, the arbitration information can include data that needs human intervention for processing, such as a comment associated with one or more of the rules by the arbitrator. The single arbitration score can be determined by weighting different rules with different weights in accordance with a predetermined weighting distribution.

The arbitration report can include a determination as to whether or not the report was warranted and whether or not to levy a penalty on the reporter-user. The arbitration report can include qualitative and/or quantitative indications regarding whether or not the report was warranted. If the arbitrator recommends levying a penalty for an unwarranted report, a score can be submitted that indicates the level of the penalty recommended. For example, the score can be calculated on the basis of the egregiousness of the accusation by the reporter-user and the history of previous reports submitted by the reporter-user.

If the arbitrator determines that the report was warranted, the arbitrator can indicate whether or not to levy a penalty on the sender-user. If the arbitrator recommends levying a penalty, a score can be submitted that indicates the level of the penalty recommended. For example, the score can be proportional to the egregiousness of the infraction. Accordingly, the arbitration report can include qualitative and/or quantitative indications of which rules were infracted and to which degree. The report can include an overall score and/or scores for particular rules, aspects of the behavior, etc., and an indication of whether the scores apply to the sender-user or the reporter-user.

The GUI can include fields for the arbitrator to enter the arbitration information. One field can accept entries indicating whether or not the arbitrator believes the report was warranted along with a reason to support this belief. The GUI can further include a field for entering a supporting reason. This field can include a menu of reasons to select from, and/or a free-text entry, e.g., a text box. Another field can accept entries indicating which rules of the social network the sender-user did not comply with, and a rating (e.g., 0-5) of the degree of noncompliance. This field can include a menu of applicable social network rules to select from. The applicable social network rules can include social network rules governing the default community of all client users 101, and/or one or more communities that the message was associated with, e.g., one or more communities that both the sender-user and the reporter-user belong to.

The arbitrator module 206 can request from the award points module 218 that points be awarded to arbitrator(s) who participated in the arbitration procedure. The penalty determination module 208, which determines a penalty based on the outcome of an arbitration procedure, can be stored and executed by client computing devices 101 and/or by social network server 104. Optionally, a penalty determination-user can oversee the penalty determination process. A penalty determination-user can be a user client via a computing device, PDA or processor or an administrator of the social network server 104 (in which the social networking site 105 may reside) that has penalty determination privileges and operates a computing device 101 that executes the penalty determination module 208. Penalty determination privileges can be determined by the administrators of the social network or by individual communities. In one embodiment, all users are awarded penalty determination privileges, but these may be repealed when abused, or when the penalty determination-user has been the subject of reports for improper communication. In another embodiment, penalty determination privileges are earned, such as by proper qualifications, peer suggestions, earning points, and using proper social network behavior for a prescribed time period.

The penalty determination module 208, when executed, receives arbitration information submitted before expiration of a predetermined arbitration time period from arbitrator units 206 that are participating in the arbitration procedure. The penalty determination module 208 can wait until the arbitration expires or all of the arbitrators designated for the present arbitration procedure have submitted their arbitration information, or whichever occurs first. The penalty determination module 208 can automatically transmit reminder messages to arbitrator units 206 from which no response has yet been received.

The penalty determination module 208 determines an overall penalty score based on all of the received arbitration information, and determines a penalty to be meted out when an infraction, e.g., noncompliant message, has been determined by the monitor module 204. The received arbitration information can include qualitative and/or quantitative information, such as text, numerical ratings, and menu selections, etc. The menu selections can be displayed as associated with quantitative or qualitative selections, but can be treated quantitatively. The penalty determination-user and/or penalty determination module 208 can evaluate the received arbitration information to generate quantitative arbitration ratings associated with the individual arbitrators, if not yet done.

Additionally, the penalty determination-user and/or the penalty determination module 208 can generate an overall penalty score for the message based on the arbitration information received from the arbitrators who submitted reports. The overall penalty score can be determined, for example, by calculating an average of an arbitration rating associated with each arbitrator. Additionally, weighting factors can be assigned to the different arbitrators so that arbitration information returned from some arbitrators is factored more heavily into the overall penalty score when applied to the calculation.

In addition, one or more choices for the penalty that can be meted out to the sender-user are determined, and a penalty to be meted out is selected. The choices and selection can be determined by the penalty determination module 206 (e.g., automatically) and/or the penalty determination user. One or more penalty choices can be selected from a list or collection of penalties stored in database 107 and accessible via the social network server 104. These choices of penalty and the duration of the penalty can be selected based on preferences for particular penalties associated with the profile of the sender-user, the rule that was infracted, arbitration ratings associated with the different rules, and/or the overall penalty score. The duration of the penalty can also be determined based on which penalty is selected to be meted out. For example, the duration can be proportional to the gravity of the infraction or the importance of the rule that was infracted.

Additionally, the penalty selection and duration can be determined based on prior history of network behavior. Repetition of offenses can be cause to select a more severe penalty or longer duration. A history of acceptable or exemplary network behavior can mitigate the penalty and/or the duration. For example, some penalties can be mitigated by redeeming points. The penalty determination process can be in accordance with a particular protocol that uses calculations. The penalty can be determined automatically by the social network server 104, by a penalty-determination user, an administrator, or a combination thereof. In an embodiment, the penalty determination can be determined collaboratively by the arbitrators that participated in the arbitration procedure.

Examples of penalties include a social indicator (visual and/or audial) associated with information displayed in association with the sender-user on the network. For example, a symbol or color can be displayed in association with the sender-user's name or photo on posted or transmitted messages or a publicly displayed profile. This can not only bring shame to the sender-user, but serve to warn other participants so that they can be wary of the sender-user's messages. The sender-user can be penalized with a probation period during which the sender-user is under higher scrutiny. For example, if an arbitration procedure is initiated in response to a message of the sender-user during the probation period, the arbitrators are notified of the probation period. The protocol for determining the penalty can include increasing the arbitration ratings or the penalty score by a selected amount during a probation period.

The penalty can include suspension from particular activities available on the social network (e.g., playing games, flagging or voting on inappropriate content, or posting messages) or from the social network altogether for a predetermined time period. The degree and duration of the suspension can depend upon the penalty score or other arbitration information.

The penalty can include expulsion from the network. Expulsion can include banning the computing device 101 that the sender-user previously used when participating in the social network and/or banning the sender-user regardless of the computing device 101 used. Expulsion or suspension can be complete or partial. During a complete expulsion or suspension, the sender-user can be blocked from using any function of the social-network. During a partial expulsion or suspension, the sender-user can be banned from selected functions. The calculations and/or determinations for determining whether to penalize the sender-user and which penalty to use can be performed and submitted automatically, e.g., without the intervention of the penalty determination-user. Alternatively, the calculations and/or determinations can be initiated, guided, and/or submitted under supervision of the penalty determination-user.

The penalty determination module 208 can include optionally generating a GUI to be displayed by a display device of the computing device 101 or the social network server 104 executing the penalty determination module 208. The GUI provides a penalty determination screen via which the penalty determination-user operating the computing device 101 or the social network server 104 can view the arbitration information submitted by the arbitrators, select information to be included in a calculation, initiate a calculation, view results, view choices of penalties that can be selected from based on the calculation results and the sender-user's profile, and submit the selected penalty. A notification of the penalty is submitted to the penalty meting module 210 to mete out the selected penalty for the determined duration, the reporter-user for notification, and/or the sender-user for notification and to provide feedback.

When a penalty is determined, it is assigned an identification code and stored in the history data of the sender-user's profile with information about the arbitration procedure and the procedure used to determine the penalty. This information can include the identification of the participants (e.g., the arbitrators and the penalty determination-user that participated in the procedures), the arbitration information, the arbitration ratings, the penalty score, and the choices of penalties that the determined penalty was selected from. The penalty determination module 208 can apply the procedures described above in a similar fashion for determining a penalty to levy on a reporter-user that submitted an unwarranted report. The penalty meting module 210 oversees meting out the determined penalty. The penalty meting module 210 is stored and executed by the social network server 104. Optionally, an administrator can oversee the penalty meting process. The penalty meting module 210, when executed, receives notification from the penalty determination module 208 that a penalty has been determined that is to be meted out to a sender-user. The notification can include identification of the penalty to be meted out and the penalized sender-user.

The penalty meting module 210 can automatically enforce penalties, e.g., without the intervention of the administrator. The penalty meting module 210 can further generate a GUI to be displayed by a display device of the social network server 104 executing the penalty meting module 210. The GUI provides a penalty meting screen via which the administrator operating the social network server 104 can oversee the enforcement. The GUI can allow the administrator to view the penalty that was determined, the present status of the enforcement of the penalty, and a history of penalties determined, currently enforced, and/or previously enforced for selected users.

The penalty meting module 210 notifies units of the social network system 100 that execute functionality which is to be used to enforce the penalty determined by the penalty determination module 107. The notification includes notification to initiate the penalty and to remove the penalty when the duration period has been completed. Examples of functionality used to enforce a penalty include displaying an indicator in association with any display of the user's name, picture, transmitted or posted message, or public profile, and restricting access to the social network.

When a user is suspended or expelled from the social network, enforcement can include using information collected about the user's computing device 101 and the user to recognize the computing device 101 or the user. For example, the social network can require that in order to access the social network, each user must sign onto the social network using identifying information, such as an ID or biometric data. Similarly, each time a computing device 101 gains access to the social network, it may also be required to present an ID (or the ID can be automatically recognized). Identification information stored with user's profiles that have been blocked from accessing the social network can be compared to identification information submitted to gain access to the social network and used to block access. By blocking access to the social network using hardware identification, the sender-user cannot circumvent the penalty by merely registering with the social network again by using a different user name or email address.

The appeals module 212 receives requests for appeals for arbitration, penalty, or point awarding determinations and oversees a review of the determination. Additionally, the appeals module 212 can oversee remanding or overriding a determination. The appeals module 212 is stored and executed by computing devices 101 and/or by social network server 104 of an appeals judge-user. An appeals judge-user can be a user or an administrator of the social network server 104 that has privileges to act as an appeals judge-user and operates a computing device 101 that executes the appeals module 212. Privileges to act as an appeals judge-user can be determined by the administrators of the social network or by individual communities. In an embodiment selected users are awarded privileges to act as an appeals judge-user, but these may be repealed when abused, or when the user has been the subject of reports for improper communication. These privileges can be earned, such as by proper qualifications, peer suggestions, earning points, and using proper social network behavior for a prescribed time period. Additionally, in order for a user to be an appeals judge-user, the computing device 101 used to participate in the social network must be able to execute the appeals module 212, such as by downloading and installing it or accessing it via an app or a webpage.

The appeals module 212, when executed, receives a request to initiate an appeals procedure to appeal a determination by the penalty determination module 206 from an appealing-user. The request can include identification of the appealing-user and identification of the decision rendered by the penalty determination module 206. The appeals module 212 can generate a GUI to be displayed by a display device of the computing device 101 or social network server 104 executing the appeals module 212. The GUI provides an appeals screen via which the appeals judge-user operating the computing device 101 or an administrator operating the social network server 104 can view the request and information associated with the request.

The appeals judge-user 212, depending on the authority vested in the appeals-judge user, can override a decision, change a penalty determination and notify the penalty meting module 110, initiate a new arbitration procedure with different arbitrators (such as a panel of appeals judge-users), or remand the decision made by the original arbitrators to the original arbitrators, e.g., with additional instructions or information. The appeals module 212 sends notification and information needed to the appropriate users, computing devices 101, or server 104, or units of the social network system 100 to implement the appeals procedure. The appeals module 212 can evaluate appeals judge-users and request from the award points module 218 that points be awarded to the appeals judge-users.

Each of units 214-222 described below, encourage positive acts using the social network by empowering users to request that points be awarded for themselves or another user. Awarded points can be redeemed in exchange for charitable acts by sponsors. For example, if a user sent a message using the social network that they received a medical diagnosis which is upsetting, another user may reply by giving positive assurances that all will be well. Another user may reply that several years ago they received the same unsettling news, but got through it fine. Such positive action are encouraged and rewarded by the social network.

The points request module 214 can be stored and executed by computing devices 101 of a user or an administrator of the social network server 104. In order for a user to submit a request for points, the computing device 101 used to participate in the social network must be able to execute the points request module 214, such as by downloading and installing it or accessing it via an app or a webpage. The points request module 214 can generate a GUI that provides a request entry screen via which a user can submit a request for points on behalf of themselves or another user regarding a message or action that demonstrates award-winning social network behavior. The points request is submitted to the award points module 216.

An administrator or user can submit a request for points on behalf of themselves or another user when they send, receive, or perceive a message that they believe exemplifies award-winning social network behavior, such as offering assistance, providing positive words, or promoting a charitable cause. Additionally, social network server 104 can automatically submit requests on behalf of a user, such as based on soliciting new users, using the social network for a predetermined period of time without receiving any penalties, participating in the social network in accordance with a usage threshold, etc. The positive acts module 216 can be stored and executed by a user's computing devices 101. In order for a user to participate in a positive acts exchange, the computing device 101 used to participate in the social network must be able to execute the positive acts module 216, such as by downloading and installing it or accessing it via an app or a webpage.

The positive acts module 216 can generate a GUI that provides a positive acts exchange screen via which a user can submit a request or respond to a request for a positive act. The positive acts exchange screen can include fields for a user to enter a solicitation for a positive act, such as encouragement, advice, words of wisdom, funding for a charitable project, a volunteer opportunity, participating as a monitor or penalty determination-user, or volunteer help. Another field is provided for selecting whether and where the solicitation should be posted, or to which users the solicitation should be sent to. Positive acts exchange screen can further include fields that allow users to respond to a solicitation, privately (e.g., only to one user, such as the user that solicited) or publicly (e.g., posted or to multiple users). The positive acts module 216 can track responses to a solicitation, verify responses and solicitations for authenticity. The positive acts module 216 can further request from the award points module 218 that points be awarded to the users that solicited or responded.

The award points module 218 receives point requests for award-winning behavior from the report module 202, the monitor module 204, the arbitration module 206, the appeals module 212, and/or the points request module 214. The award points module 218 can further verify award-winning behavior upon which the requests are based before awarding points. Examples of award-winning behavior for which points can be earned include performing positive acts requested via the positive acts module 216; reporting a noncompliant message; and participating in an arbitration procedure, e.g., as a monitor-user or an arbitration-user, or an appeals judge-user.

The award points module 218 can be stored and executed by one or more computing devices 101 or server 104. The award points module 218 can automatically award or verify points, e.g., without the intervention of a user or the administrator. A verification message can automatically be sent to a user, e.g., a user that requested a positive act, or a user that participated in a monitoring or arbitration procedure. The verification message can include checkboxes that can be automatically read by a computing device. Upon verification, the points can be automatically determined in accordance with a predetermined schedule of points and awarded. Alternatively, the award points module 218 can award or verify points under the supervision of one or more users and/or the administrator.

In an embodiment, the award points module 218 can generate a GUI that provides a screen via which a user or administrator can supervise awarding or verification of points. The screen can include fields for viewing the request, requesting verification from a user identified in the request as appropriate for helping with verification, receive feedback, submit awarded points to an accounting module (not shown), and send notification to the user that is receiving the awarded points.

The process for receiving requests for points and awarding points can be performed similarly to the process for reporting noncompliant messages and determining penalties. The process can include selecting an arbitrator panel and performing an arbitration process to determine whether or not to award points and how many points to award. A decision for awarding points can also be appealed, such as when a point award request is refused or minimized. The appeals module 212 can receive and process the appeal requests. Penalty and point award determinations can be subjected to inspection, such as an audit by an administrator, or upon a justified request by another user. Audits can be performed on a random basis, or when a suspicious pattern is detected.

Awarded points can be sent to the accounting module (not shown). The accounting module keeps track of points awarded to users and points used by users. The accounting module performs transactions with the points, such as when points are redeemed. In certain embodiments, users may further have the opportunity to reduce a penalty using points that were awarded or by earning points. The sponsorship module 220 can process and update sponsorship offers from sponsors, such as corporations, organizations, or individuals. The sponsorship module 220 further publishes the sponsorships to users, e.g., via a GUI, such as using a webpage or app screen, so that the users can view a schedule of fees (points) and services and select an entry from the schedule to redeem points.

The redeem points module 222 can communicate point redemption selections by a user 111 to the sponsor that sponsored the selection. The redeem points module 222 can further oversee redemption of the points by communicating with the accounting unit, the user 111, and/or the sponsor of the redemption selection for transacting the redemption. Additional units can be provided, for example one or more units, such as for playing games; storing, posting, and/or editing media, such as photographs and videos; and creating and sending greeting cards to other users. These units can use points as currency, instead of or in addition to a traditional currency. Points can be earned by winning games or receiving positive feedback (similar to “likes”) for posted media. Points can be used to purchase services or goods from the units, such as games, storage for storing media, and ordering hardcopies of photographs.

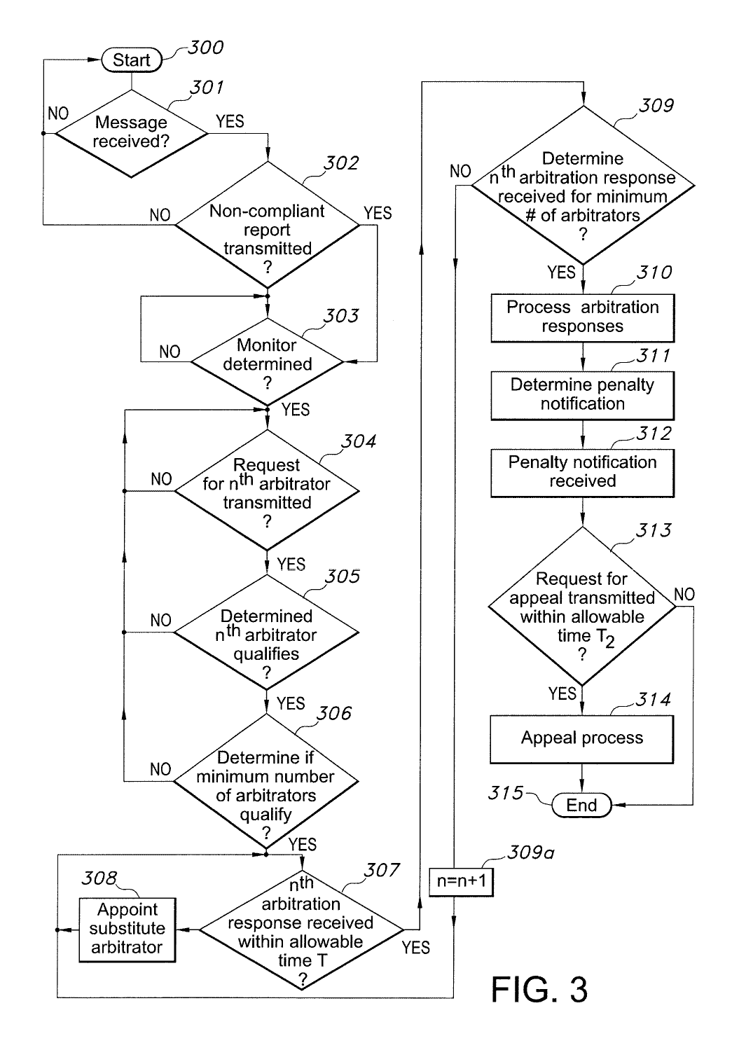

FIG. 3 shows an example of a monitoring sequence in which a sender-user sends or posts a message to the social network. At step 300, the system will commence the example method. The method begins with checking whether a user has posted a message at step 301. If so, the process next determines whether the message has been reported as non-compliant by a second user or reporter at step 302. If not, the process will commence again at step 300. A second user may reports the message as non-compliant at step 302 if the user deems the message as noncompliant with the policies set forth by the social network. In certain embodiments, the non-compliance may be applicable and reported for a certain subset of users or a community of users.

In certain embodiments a group of users may be members of a community or members of a default community. In the method shown at step 302, a second user or reporter reports the message as noncompliant by transmitting a noncompliance report in step 302. The report module 202 as shown in FIG. 2, enables the functions related to reporting the message in step 302. In certain embodiments, when the report is generated, the reporter-user can select the specific rule(s) of social network behavior that apply to community that were not complied with, and quantify or provide a certain degree of perceived noncompliance. The report is transmitted to a monitor who oversees an arbitration process for processing the report. The monitor may be a user, an administrator, a processing device, or a combination thereof. In an embodiment, the reporter user can select the monitor for the current report. In another embodiment, the monitor is selected based on the profile of the sender-user. In yet another embodiment, the monitor is predetermined, such as a designated peer in the community of users, an administrator of the community, or an administrator of the system 100. Generally, a monitor is considered a user of trust or choice among a given set of users in the social networking environment that has a history of compliance with the policies of the social networking site and ensures integrity of any posted content in such role.

In any event, the monitor may transmit arbitration requests at step 304 to n number of arbitrators to solicit them to join the current arbitration procedure for the currently reported non-compliant message. The arbitrators can be in certain embodiments, qualifying users, an administrator of the social network or an administrator of the social network community. The arbitrators may be restricted to members of the community that qualify as arbitrators. In certain embodiments, the arbitrators may be limited to monitors. In step 305 of the shown method, it is determined whether the nth arbitrator qualifies as an arbitrator. If so, the system will determine if the minimum number of arbitrators has been selected as qualifying in step 306. If so, the method will determine whether each of the arbitrators submitted an arbitration response within a pre-determined or configurable minimum allowable time period T. Each of the n arbitrators can view the arbitration request on a screen provided by the GUI of a webpage, application user interface page or similar user interface display on the client computing device or PDA, or similar device. Additionally, the monitor can submit a notification to the penalty determination module 208 shown in FIG. 2, to notify that an arbitration procedure has been initiated, which triggers the start of an arbitration time period T.

The arbitrators can submit arbitration responses that include arbitration information to the penalty determination module 208 as shown in FIG. 2. The penalty determination module 208 processes the arbitration responses that are received in step 307 prior to the maximum allowable time for submitting responses, time period T. In the shown method, if arbitration responses were not received from arbitrators within. However, an arbitrator did not submit an arbitration response 310 before the maximum allowable arbitration time period, then the system will appoint a substitute arbitrator at step 308 for the nth arbitrator that did not submit an arbitration response within time period T. The method next determines whether each arbitrator has submitted an arbitration response within time T by advancing the counter n to n=n+1 at step 309a and returning to step 307 to check submission by the n^{th} arbitrator within time T.

The server 104, as it executes the penalty determination module 208 of FIG. 2, receives the arbitration responses and processes the responses in step 310 with a determination of the specific penalty in step 311. The server 104 then transmits a penalty notification 312 to the user providing the original user with notification of the penalty that has been determined by the arbitrators in step 311. The user deemed non-compliant can submit a request to appeal the determination before expiration of an appeal time period as shown in step 313. A determination is made if a request for an appeal is performed within a maximum allowable time period T2. If so, the Appeals module 212 processes the appeal in step 314 as transmitted by the non-compliant user at step 313. If the system is not in receipt of the request for an appeal, the disclosed embodiment will end at step 315. In the disclosed embodiment, the penalty determined by the penalty determination module 208 of FIG. 2, includes a negative behavior indicator with each message transmitted by the user that can be accessed by a member of community. The penalty can be extended to apply to messages transmitted to members of any other group that applies the rule determined to be an infraction. The penalty is applied until expiration of a selected or pre-determined penalty time period. In other embodiments, if the infracted rule applies to users having a particular characteristic identified in their profile, such as within a particular age range, the notification can be limited to users having that particular characteristic, e.g., within a defined age range. In another embodiment, the penalty is applied to all messages sent by sender-user regardless of the users that can access the message or the group(s) to which they belong.

As an example, a set of messages may be determined to cover a particular penalty as determined by the Arbitration process because they were transmitted to members of community (e.g., users) after the penalty was determined and before the penalty time period expired. In yet another example, a particular message may be deemed as not qualifying for a penalty notification because it was sent to a member that is a member of a default group. A user transmitting a message to a community member in the social networking site 105, may be a recipient of penalty notification because it was transmitted to users who, even though may not be a member of the community, may be a member of another group that may similarly apply the particular rule determined to be infracted.

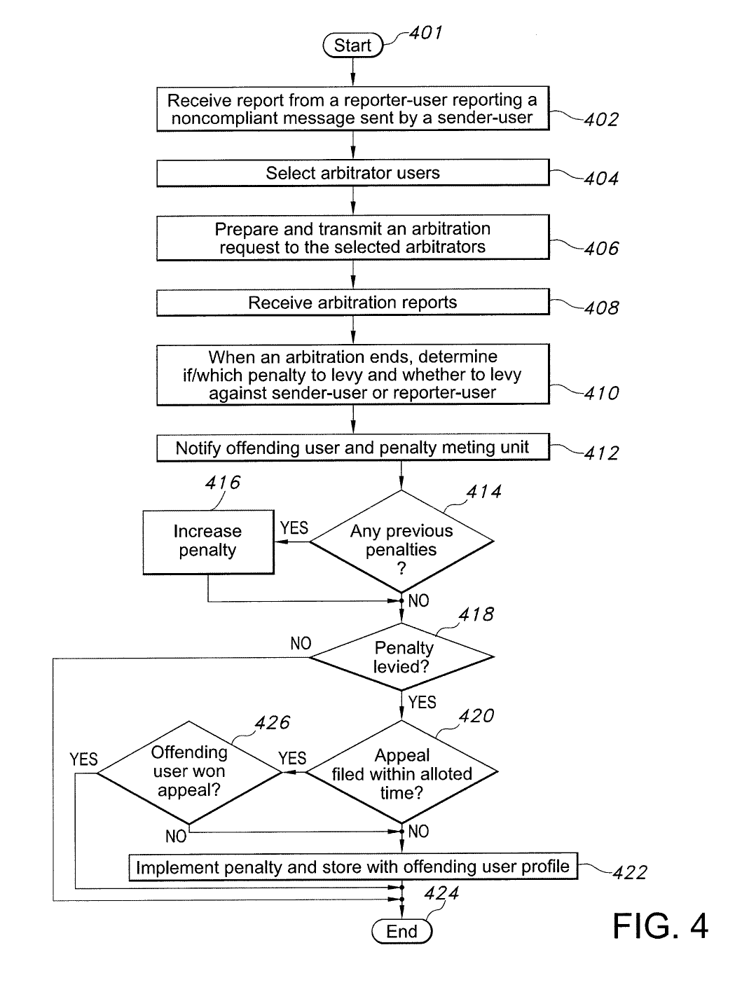

FIG. 4 is a flowchart that illustrates an example method 400 of monitoring social network behavior using the monitoring system 100. The method 400 begins at operation 402, in which a report is received from a reporter-user that transmits using the client device 101, a report that a message transmitted and/or posted by a sender-user is noncompliant. At operation 404, a panel of one or more arbitrators is selected. The prospective arbitrators may submit their preferences to the social networking site to enlist as a potential arbitration when an arbitration arises. Alternatively, an administrator can be selected to arbitrate. The determinations can be made by a processing device, such as the social network server 104 as shown in FIG. 1.

At operation 406, an arbitration request is transmitted to each arbitrator that is determined by the system, which in certain embodiments, may include an indication of a pre-determined arbitration period within which the arbitrator transmit their arbitration report. An arbitration report is transmitted by the arbitrator before expiration of the maximum allowable arbitration time period in step 408. The arbitration report can include a determination as to whether or not the report was warranted and whether or not to levy a penalty on the sender-user or the reporter-user as shown in step 410.

At operation 410, once the arbitration time period expires, and/or in other embodiments, once all of the selected arbitrators have replied with arbitration responses, the arbitration report(s) are processed and a determination is made by the penalty determination module 208 of FIG. 2 if the report was warranted, whether to levy a penalty, which penalty to levy, and upon which user to levy the penalty (based on the determination about whether the report was warranted). The determination can be performed using quantitative data from the arbitration reports and performing an algorithm on the data. The algorithm can apply different weights to the ratings or scores based on the particular rules and/or arbitrator that generated the report. At operation 412, a notification of any penalties to be meted out is sent to the user for which a penalty has been determined (e.g., the sender-user if the report was warranted, else the reporter-user) and to the penalty meting module 210. If no penalty is levied then notification can be sent to the sender-user informing the sender-user that a report was made, with no penalty levied. In addition to the above notifications, additional notification can be transmitted to the reporter-user and/or the arbitrators informing them of the outcome, however this notification can include limited information, such as whether a penalty is levied, and to which user the penalty is transmitted.

At operation 414, a determination is made whether there is a history of previous penalties associated with the user (e.g., the sender-user if the report was warranted, else the reporter-user) for which a penalty has been determined. If it is determined at operation 414 that there is a history of previous penalties, the method continues at operation 416. At operation 416, the penalty is increased. The increase can be based on how many previous penalties were levied on the user and how long ago the action occurred that prompted the penalty. The method ends at step 418. However, if it is determined at operation 414, that there is no history of previous penalties, the method determines at operation 418, whether a penalty was levied on either the sender-user or the reporter-user. If it is determined at operation 418 that a penalty was not levied, the method ends at operation 424. If it is determined at operation 418 that a penalty was levied, the method continues at operation 420.

At operation 420, a determination is made whether an appeal was transmitted before expiration of an arbitration time period. If it is determined at operation 420 that an appeal was not requested, the penalty is implemented in step 422 by restricting the participation in the social network of the user receiving the penalty. Additionally, information about the penalty, including identification of the infracted rule, the nature of the infraction, and the penalty levied are stored with historical information about the offending user. The method ends at operation 424.

If it is determined at operation 420, that an appeal was indeed requested with receipt of such request by a receiver or the network server 104, the appeal process is commenced at operation 426, wherein a determination is made whether the offending user won the appeal. If it is determined at operation 426 that the appeal was lost, then the method continues at operation 422, and the penalty is implemented, after which the method ends at operation 424. If it is determined at operation 426 that the appeal was won, the method ends at operation 424 without implementing the penalty on the user that posted the message or content on the social networking site.

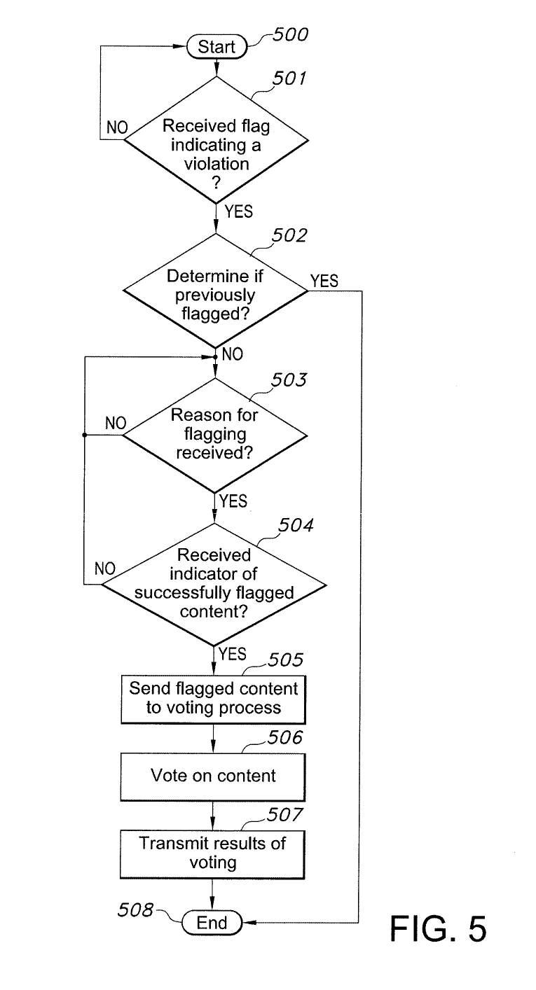

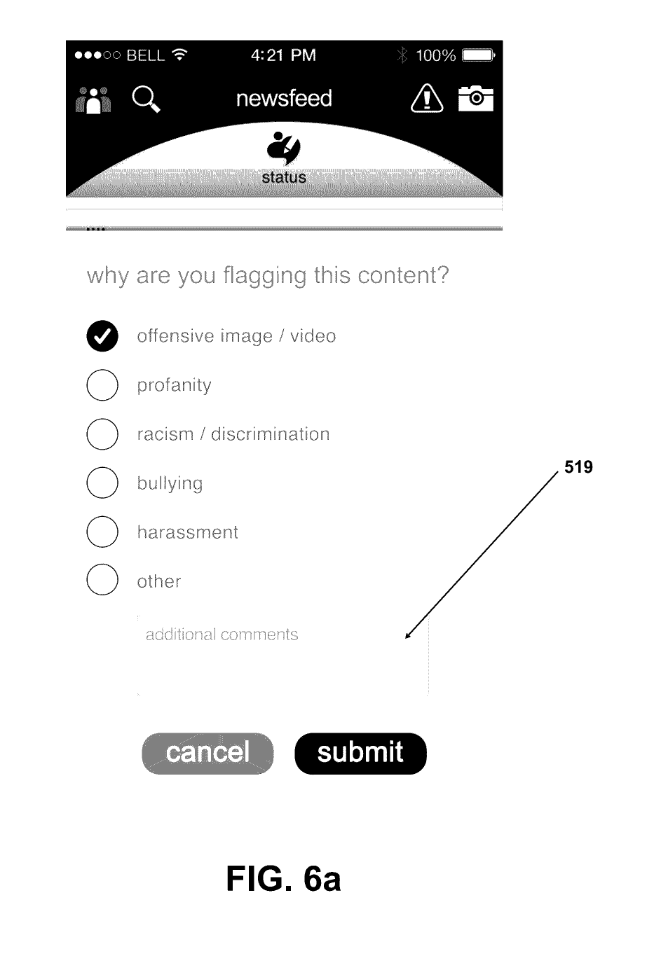

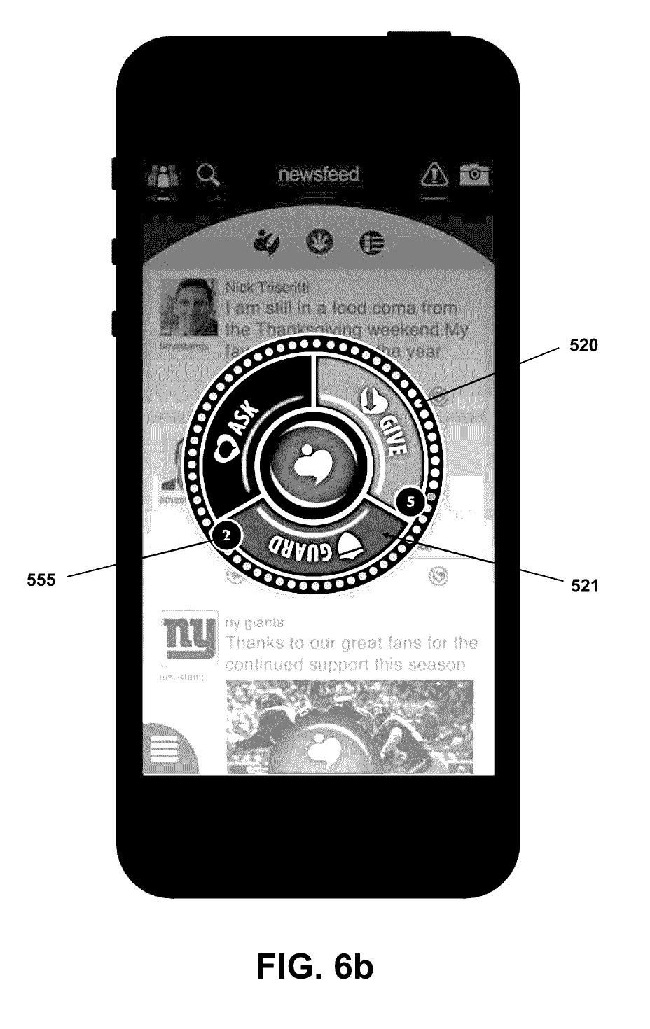

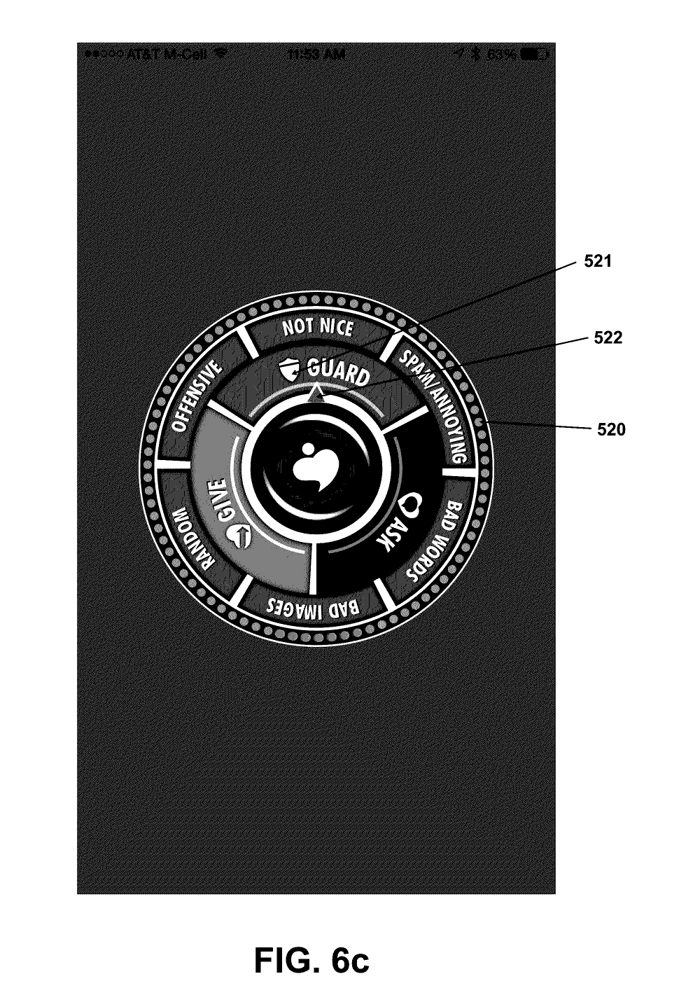

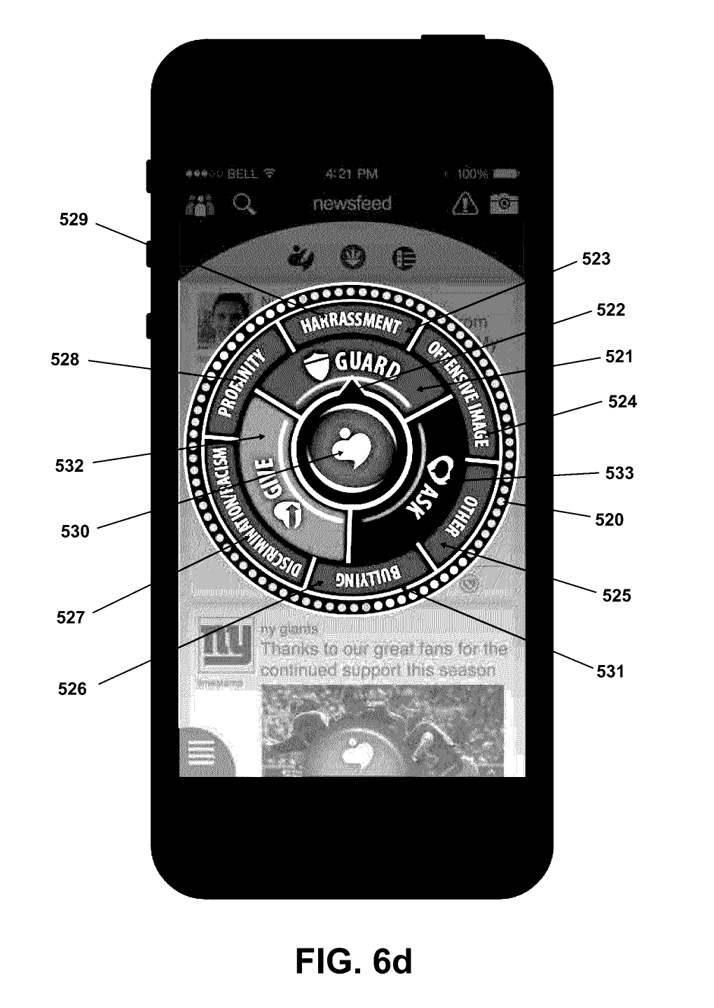

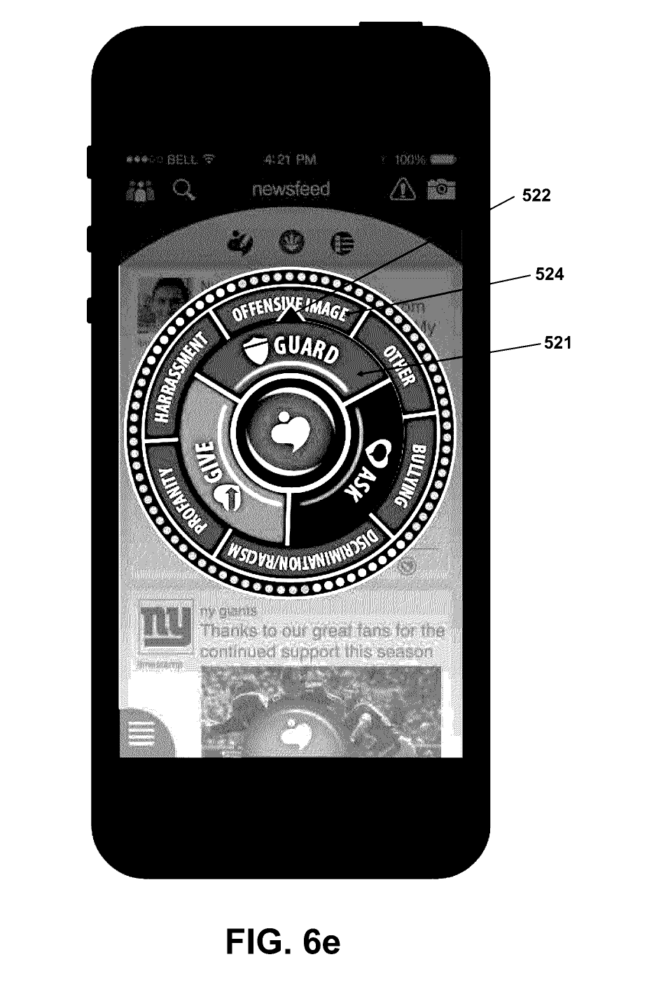

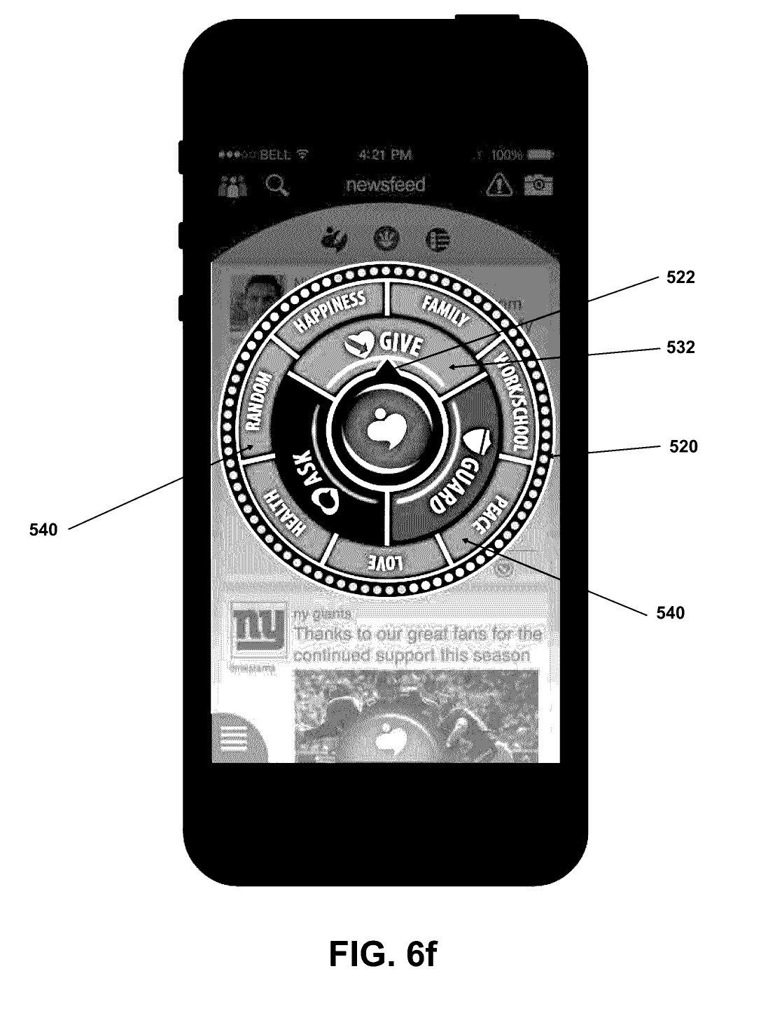

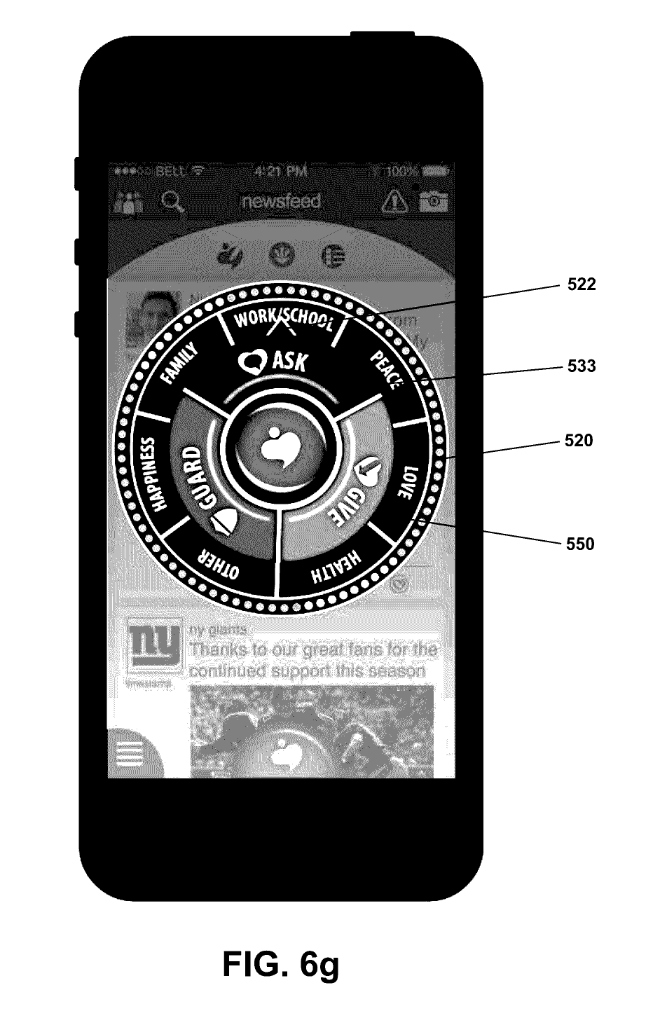

In yet another embodiment of the integrity based social networking site 105, is a method of guarding the social platform implemented by the site 105. The Guard flagging system empowers users of the site 105, with the ability to determine content as inappropriate. The users can flag posts which they believe in their subjective opinion is inappropriate but, which furthermore violates the predetermined policies and terms of service of the social networking site 105. A post may be textual, include pictures, images, video or other forms of content. Once an item is flagged, it is distributed via the networking environment to the entire platform where users are provided with the ability to vote whether the flagged post is in compliance with the policies/terms of service. This permits the users to cooperatively enforce an integrity based social media experience as possible. A contemplated embodiment of the flagging method is shown in FIG. 5. As users navigate through the social network site 105 and related posts that other members of the site have reviewed, it provides users with the opportunity to report any content they deemed to be inappropriate to the social media site in their opinion. In an embodiment, the user can provide a newsfeed as shown in FIG. 6a providing the explicit reason for flagging the particular content. For example, the content may be deemed to be offensive, use of profanity, reflective of racism, bullying, harassment or another other reason that the reporter can enter in item (519). In alternate embodiments, alternate reasons may be indicated such as offensive, not nice, spam/annoying, random, bad images, and/or bad words as shown in FIG. 6c in the outer wheel selections (520).

An embodiment of the flagging method begins at step 500. The user determines whether a post is a violation of the terms of service. The user will transmit a flag to the social networking site 105 thereby notifying that a post violates terms of service at step 501. The user may tap on for example, a flag icon on the display screen or user interface which in effect, alerts other users of the non-compliance. At step 502, the method will determine whether the same user had previously transmitted a flag for the same content to prevent flagging by the same user more than once. If so, the method ends at step 508. If not, the method will continue to step 503 where the method next determines whether a reason for flagging the particular content or post was received by the site 503. A menu of specific reasons for flagging content as inappropriate and possibly an infraction of the terms of service is shown as an example in FIG. 6a. The particular content may be deemed either offensive to a user, and/or is associated with bullying, harassment, contains abusive or vulgar language, contains nudity and/or other reasons which the user may further specify by entry of a description of such reason that is transmitted to the server for processing. The user, in certain embodiments, may select from a menu of options the specific reason for flagging the particular content. In alternative embodiments, the reasons may include offensive, not nice, spam/annoying, bad words, bad images, and random as shown in FIG. 6c as shown in the outer wheel of selection items 520.

Additionally, the user may enter a personal description regarding the reason the user is flagging the content. Once an indicator is received that the content was successfully flagged in step 504, the post is next sent to a guard feed in step 505 in which all users will continue to see the post. However, the content will include a flag icon or other indicator associated with the post so other users have an indication that the content is under review as indicated by the system's wheel menu 520 of kindness, particularly the guard selection 521 from the wheel of kindness 520 as shown in FIG. 6b. A number within a circle indicator 555 may appear on the user's wheel of kindness on the guard selection 521 as shown in FIG. 6(b), for example. If no indication is received that the content was successfully flagged, the method proceeds back to step 503. Once the guard voting unit has voted on the particular content in dispute in step 506, the results of voting are transmitted to the computing device of the original user that published the post under review in step 507. The flagging method of the disclosed embodiment ends at step 508.

It is noted that users generally will navigate the network viewing posts of other users. Posts may be textual, pictures or other video content. Each post may contain in certain embodiments a flag icon, which the user may tap using a touchscreen interface or other command entry interface or key of the user's computing device 101. The Guard 521 selection is indicated in FIG. 6c, by arrow or other indicator 522. FIG. 6d shows an example wheel of kindness 520 in which the guard 521 feature is selected by arrow indication 522 with the reason for flagging the content additionally listed in a sub-menu 531 surrounding the guard selection 521. Additional listed selection items in the main menu from the wheel of kindness 520 is the Give selection 532 and Ask selection 533 which will be described in greater detail hereinbelow. In certain embodiments, the user reporting the content using the guard 521 selection, may report the content as in the shown example, by selecting one or more of the following menu items, harassment 523, offensive image 524, bullying 526, discrimination/racism 527, profanity 528, or other 525.

FIG. 6e shows an example where a user has reported a post of another user to be an offensive image 524 as indicated by selection of the item 524 as indicated by arrow 522. One the user has flagged a post using the Guard selection 521, the network of users may congregate and vote individually on the flagged post. Such voting may effected be in real-time, near real-time or even on a delayed time bases. The flagged item is reviewed and the user is sanctioned appropriately within a predetermined period of time that may be set by the user flagging the post or may be pre-set by the service provider for voting on such posts. In some embodiments, flagged posts result in the following outcomes: a vote of yes—meaning that other users deems the content does violate the policies/terms of service and should not be included in the social media site 105. Alternatively, other users may vote that the content does not violate the terms of service and should remain posted on the social networking site 105 for other users to view. The social media networking site 105 in certain embodiments may also provide the opportunity to flag user comments, any posted Asks 533 and Gives 532 in accordance with the wheel of kindness 520 and described in further detail hereinbelow. In certain embodiments, the flagged content is not visible to other members of the social media network other than the voters that have been selected to vote on the appropriateness of the content.

FIG. 6(f) is an example of the wheel of kindness implemented so that a user with the selection of the Give 532 sub-menu as selected with arrow 522, contributes by selection of a positively toned comment from an additional sub-menu of selection items. Examples of sub-menu items 540 include random, happiness, family, work/school, peace, love or health 540. A user may post a comment to a specific user using the wheel of kindness 520.

FIG. 6(g) is an example of the wheel of kindness implemented so that a user with the selection of the ASK selection item 533 using the wheel menu 520 may request feedback from users. Example of categories of sub-menu selection items 550 for the ASK selection item 533 may include family, work/school, peace, love, health, other, or happiness. Other users may post comments to the user asking for a positively toned comment to assist the user with the particular category.

The system implements a voting process to determine whether the majority of user have voted that the content as inappropriate and therefore, seek to guard the network from inappropriate posts. The flag voting process may be implemented to determine the number of users that are required to determine whether the content should be removed from the networking site 105.

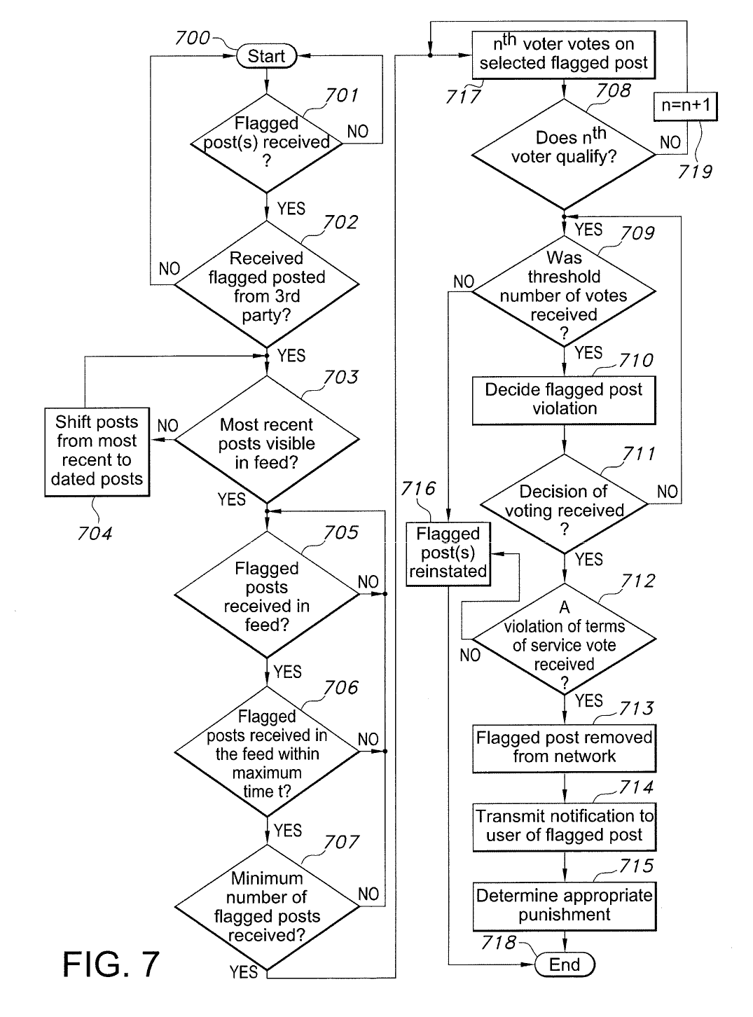

FIG. 7 is an example embodiment of the flag voting process implemented with the social media networking site of FIG. 1. The example method commences at step 700. The user may proceed by navigating to the guard feed and selecting the guard menu item as shown in FIG. 6(c). The example method next determines if flagged post(s) have been received in step 701. If not, the method proceeds to step 700 to await and determine if any flagged posts have been received. Otherwise, the method proceeds to determine if the flagged posted content was received from a 3rd party (eg. any of the flagged posts originate from a third party other than the user that is currently voting since a user is not permitted to vote on his own posted content). If so, the method will proceed to step 703 to determine if the most recent posts are visible (example, as visible to the user by viewing the guard feed selection item 521). Otherwise, the method will shift the posts from the most recent to the more dated posts at step 704. The method next determines whether the flagged post(s) are received in the feed at step 705. If not, the method returns to step 705 until the flagged posts are transmitted to the flag feed. The method next determines if the flagged posts were received in the feed within a maximum allowable time t at step 706 which in certain embodiments, t may be a predetermined value and/or a configurable value as determined by the system. If the time period is met, the method will next determine if a minimum number (eg. quorum number necessary to proceed) of flagged posts were received in step 707. In certain embodiments, that minimum number may be set to 1 and in other cases, the minimum number may be set to a higher number. If condition not met that a quorum number of posted received in feed, the method will return to step 705 to determine whether the flagged posts were received in the feed at step 705. If so, the process will next check in step 706 if the content was received in the feed within a maximum allowable time period, which is configurable. For example in certain embodiments, t=1 minute. This short time period prevents potentially inappropriate content from being visible in the feed to other users. The element t may be set based on certain factors of the user posting the content, number of users in a region, number of user matching the characteristics of the user that posted the content, the age range of the user posting content, other specific characteristics of the user posting the content such as race, orientation, religion, etc.

The remaining time that a user can vote may be visible to the user that is voting or will vote on the flagged content. The voter may vote for example, yes or no, on the flagged post. A user may also be able to view the number of users that voted for or against the flagged post.

In certain embodiments, the flagged posts, with the most recent appearing at the top of the guard feed, will appear on the flagged feed for a pre-determined period of time. Such pre-determined period of time is configurable. The user of the example embodiment may also be able to visibly see the time remaining on the guard feed within which a user or voter can cast a vote on the flagged content. Following step 707, the method will next proceed to step 717 in which an nth voter votes on a selected flagged post received in the feed within the maximum allowable time. The method next determines whether the nth voter qualifies as a voter in step 708 and if so, the vote of the nth voter will be cast and received. If the nth voter does not qualify, counter n is advanced by 1, wherein n=n+1 at step 719 and proceeds to step 717 in which the nth voter votes on the selected flagged post. A maximum number of allowable voters may also be set and may be configurable in certain embodiments. The process proceeds to step 709 in which it is next determined if the threshold number of votes are received from the n qualifying voters. If not, the method will proceed to step 716 at which time, the flagged post is reinstated since threshold number of qualifying voters have not voted and/or have not been received within an allowable time period on the flagged content and the method ends at step 718.

The method otherwise, proceeds to step 710 at which point, to determine whether the vote on the flagged post is indeed a violation of the terms of service. The method will determine whether the decision on the voting process is received in step 711. If not, the method will return to step 709 to determine if the threshold number of votes were received and proceed therefrom. If the decision on the voting process is received, it is next determined whether the decision determined a violation of terms of service at step 712. If not, the system proceeds to step 716 to reinstate the flagged post and ends at step 718. Otherwise, the method proceeds to remove the flagged post from the network at step 713. The process next transmits a notification to the publisher of the flagged post at step 714. Appropriate punishment in accordance with the terms and policies of the social networking site, is next determined in step 715, after which the example method ends at step 718.

In certain embodiments, as users flag content that they subjectively deem inappropriate and a violation of the terms and policies of the social networking site, the users of the networking site may vote on such posts as flagged by other third party users of the social networking site. A predetermined minimum number of users (example, a quorum of 12 different users) must vote on each flagged item to determine a final outcome as described in the example method of FIG. 7. If a fewer number of predetermined users have voted on a particular flagged post, and the predetermined voting time has expired, the post may remain viewable in the network. However, a user may be able to flag it as inappropriate and the content is thereafter returned to the Guard feed for appropriate voting. There are various levels of penalty of content deemed and determined to be inappropriate using for example, the method of FIG. 7. It is considered a deterrent to enact such penalty levels from posting content deemed a violation of the terms and services of the social networking site.

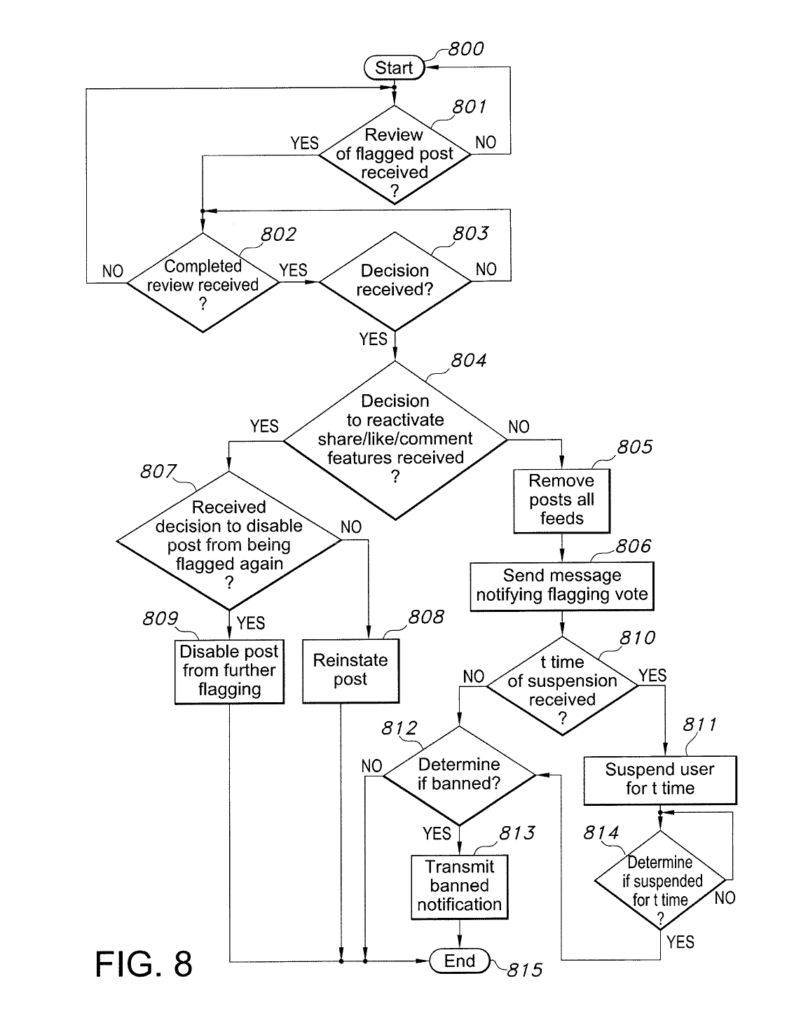

Another embodiment of the social networking site includes a method of determining the consequences of content deemed inappropriate in accordance with the method for example, of FIG. 7. FIG. 8 is an example method of making a final determination on whether to disable a post, reinstate a post, suspend a user or ban a user. Additionally, in certain embodiments may be based on a points based system. A user may be rewarded for a post by being rewarded with actual points that is affiliated with their user account of the social networking system. If their particular votes do correlated with that of the majority's decision, those users will be rewarded additional bonus points. If the user's vote is not in accordance with that of the majority of the community of users, the user will not receive any additional points. This type of reward system will be an incentive for users to continue voting on flagged content that appears on the flag feed.

The example method of FIG. 8, commences at step 800. The process first reviews the flagged post at step 801. If a completed review was received in step 802 the process next determines whether the decision was received in step 803. If so, the process proceeds to step 804 to decide whether to reactivate share/like/comment features. If the system decides that it will not reactive share/like/comment features, the process next proceeds to remove posts from all feeds in step 805. The process will next send a message notifying of the flagging vote in step 806. The process will next check the amount of time t, if any, that the suspension of the user is allotted in step 810. If no time for suspension is received, the process will determine if the user has been banned from the social media site in step 812 for any inappropriate posting of content. If so, the process will transmit a banned notification to the user in step 813, at which time, the method ends at step 815. If a discrete time t, (eg. a time period of 4 hours, 8 hours, 3 days, or other time period) within which to suspend the user for a particular violation or offense is received in step 810, the process will suspend the user for t period of time in step 811. Then the process will next determine if the time period has passed in step 814. If yes, the process will next determine if the user has been banned in step 812 and if so, will next transmit a banned notification to the user in step 813 and the process ends at step 815. If not banned, the process ends at step 815.

Alternatively, if a decision to reactivate share/like/comment features is received in step 804, the process next determines if it received decision to disable the post from being flagged again in step 807. Such decision is indicative that the post was not properly flagged and is in fact appropriate content. If no decision received to disable the poste from being flagged is received in step 807, the process reinstates the post in step 808, removing the previous flag indicator. However, the content may be subject to further flagging by other users in the future and the process ends at step 815. If the system indeed receives a decision to disable the post from being flagged again for inappropriate content or another reason, the system will disable the post from being further flagged in step 809 at which time, the content remains on the networking site and is no longer subject to scrutiny of the flagging system and voting process as described in the example method of FIG. 7. The method then ends at step 815.

In another contemplated embodiment, should a user attempt to vote on more than a discrete number of predetermined posts within a discrete period of time T, for example 1 minute, the user will receive a notification that they should read each post more carefully. This type of monitoring permits the social networking site to tailor the user's behaviour in accordance with the terms and policies of the social networking site.

In yet another contemplated embodiment, the social networking site may award points to peer reviewers. This method serves the benefit of tempering inappropriate or excessive flagging by certain users of other users' content. So if a user for example does not have at least a threshold percentage (for example 45%) of their posts ratified by the community after having flagged a certain predetermined number of posts, the user will receive a warning from the system of potential inappropriate flagging. The user may even have their flagging rights revoked for a certain predetermined period of time, for example, 24 hours, if the same user is deemed to have violated the terms and policies of the social networking site. For example, the system can be configured that after a certain number of flags, n number of flags, by the user of other content, such user may receive yet another message that their flagging rights are revoked for t period of time (example, 72 hours) and the wrongful flagging count will be reset to zero. In yet another embodiment, such users will have their flagging privileges suspended for wrongful flagging for a predetermined number of times. Each user has the ability in certain embodiments to customize preferences to view subject matter of their own choice or preference. On a flag feed, each user may select/filter by category. The flag feed may include only post the user is interested in voting on and as determined by the selected filter.

It is further contemplated, that when a user flags another post, they will be updated with the result of the voting process. The user that flagged the post will receive a notification that states if the post the user flagged was voted on favourably or otherwise by the Guard voting process. If the content the user flagged was deemed to be a violation of the terms of service, it will be removed from the networking site in accordance with the terms of service. If the flagged post is not deemed to be a violation of the terms of service, the post remains on the network and the ability to flag such content is available through the flagging processes of the social networking site.

Another contemplated embodiment, allows users to comment by using a touchscreen interface on a PDA or computer screen display with an icon for flagging content which may be located adjacent the actual comment for a more user-friendly interface. The user receives a notification that the patrol has voted in the user's favour and the post has been reinstated. Or the patrol has not voted in the user's favour and the post has been removed. As shown in FIG. 6d, the user may select guard 521 as indicated by arrow 522 from the inner wheel menu 520 of selection items including Give, Guard and Ask items in the shown example. The guard menu includes a number of items to choose from for flagging content such as harassment 529, offensive image 524, other 525, bullying 526, discrimination/racism 527, or profanity 528. An example in which offensive image is chosen is shown in FIG. 6e with the indicator 522 shown pointing to the outer wheel menu selection item 531 indicating an offensive image 524.

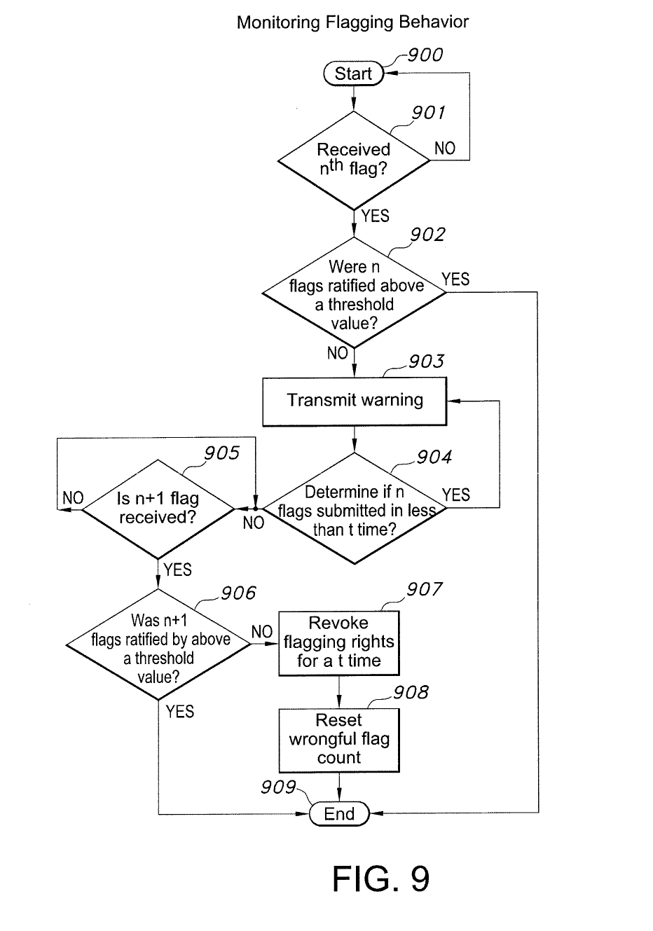

An example method as shown in FIG. 9 is a process for monitoring a user's flagging activity and/or network behavior and can temper any misuse of the flagging process as determined by the system. The method begins at step 900. The method determines if an nth flag was received by the system at step 901 from the same particular user, wherein n is generally configurable but, may be 1 or a number greater than 1. If so, the method next determines if the n flags of the particular user have been ratified by other users as being ratified by above a predetermined threshold value (for example, 45%) of users. If the system determines that all the n number of flags have been ratified above a threshold value, the method ends at step 905. The user's flagging behavior is compliant with the network site. If it is determined that all of the users's n number of flags have not been ratified (eg. approved as appropriate) as above a threshold value, a warning is transmitted to the user at step 903. A warning may include for example, please take more time to review the content and flag as inappropriate. The method next determines if all n flags were submitted each in less than t period of time at step 904. If so, the system returns to step 903 to transmit a warning to the user to transmit the flagged content in greater than t period of time. This tempers impulsive flagging behaviour and possibly flagging behaviour in which the user was not realistically considering the content within a certain period of time or merely flagging repeatedly in a small period of time, eg. t=5 seconds. The process otherwise proceeds to determine if additional content was flagged by the user in step 905 and if not, awaits any additional content being flagged by the user. If received, the method will determine if that n+1 flagged content item was ratified by the community of users as flag worthy content (eg., deemed as inappropriate content by a majority of users and thereby flagged appropriately in accordance with the policies of the social networking site). If ratified by above a threshold value, the method ends at step 909. Otherwise, the method proceeds to step 907 to revoke the user's flagging rights for t period of time for inappropriate flagging behavior. The process will next reset the wrongful flag count in step 908 and the method will end at step 909.

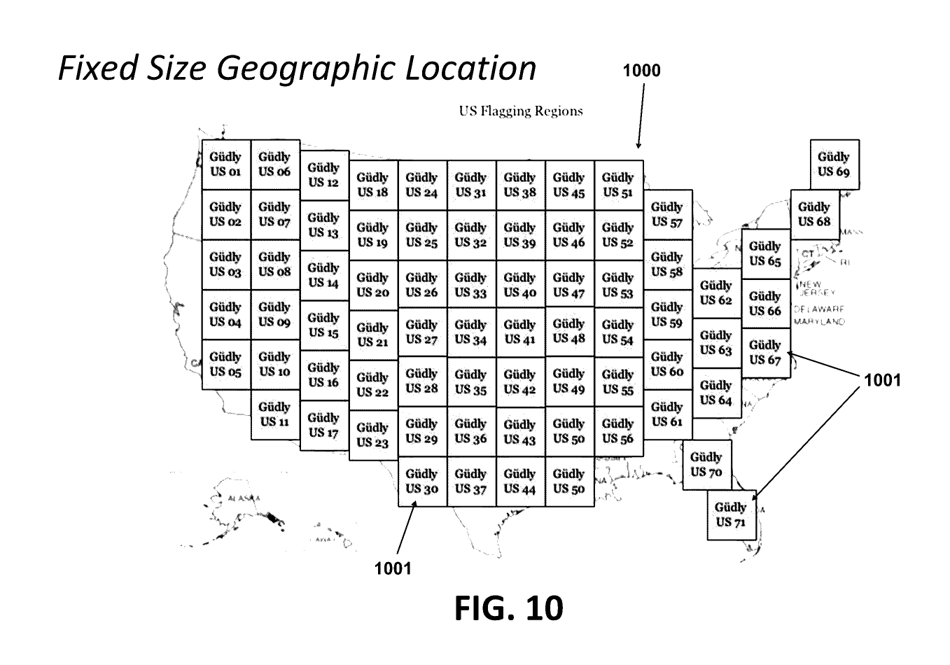

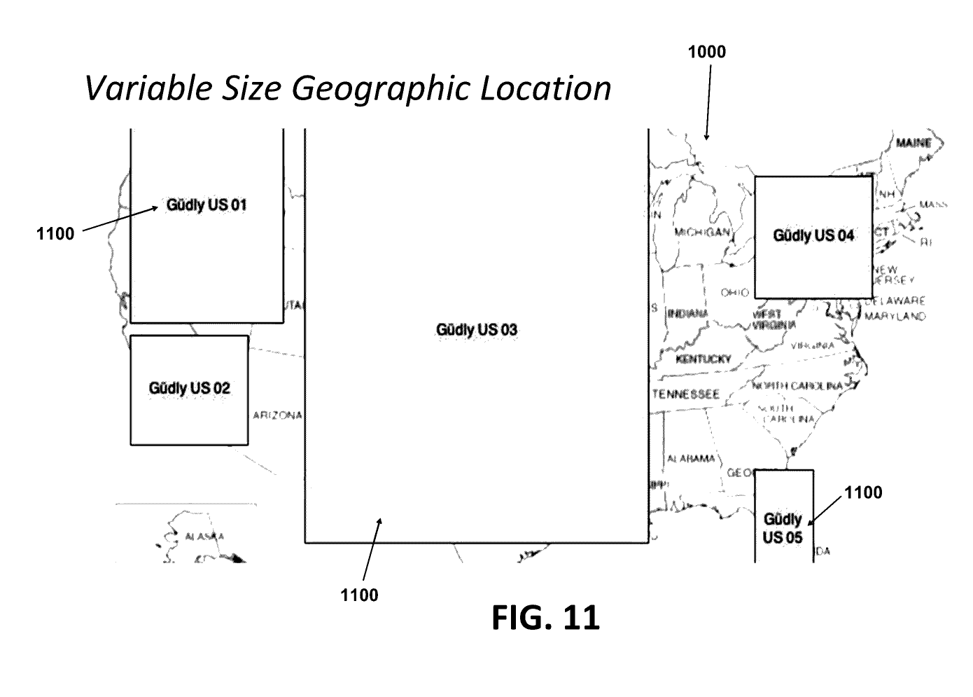

A flag guard module is contemplated that includes the selection of guard voters and/or further review/decision on flagged content which may be based various elements such as geographical location, the fixed size geographical location and/or configurable geographic location models. It also may include an active user model, approach such as a nearest active user model, random active user model, and/or distribution/fair share approach model. The geographic areas of the community of users in the social networking site may be divided into different geographic location groups. The purpose of this distribution scheme is to ensure that similarly situated or like-cultures review flagged items to ensure consistency of any sensitivity to potentially inappropriate post(s). When flagged items are reviewed within the guard feed, in certain embodiments, the feed is distributed to specific geographic groups associated with the user of the flagged item. Referring to FIG. 10, is a fixed size geographic location model in which the system will identify users in fixed sized blocks and/or will identify users within the area the user is location. As shown in FIG. 10, the major areas of a geographic region, in the shown example, the United States 1000, are sub-divided into discrete geographic areas or sub-regions 1001 which in the shown embodiment may be fixed size geographic locations or areas 1001. FIG. 11 is another embodiment in which the geographic areas or sub-areas may be variable in size as indicated by areas 1100.

The system will generally link a newly registered user to the social networking site 105 based on the geographical location which is indicated by sub-regions 1001 or 1100 depending on whether the regions are based on a fixed size of FIG. 10 or a variable sized model of FIG. 11. In the event a flag guard is required for reviewing content posted by a user 111 or client 101, the system may base the appointment of a flag guard by using the geographical groups the user is associated with and furthermore, use similarly situated geographical regions 1001 or 1100 as a basis for finding guard team members. In certain embodiments, the system may additionally consider additional factors such as commonality of the users being selected as flag guards with the user that the posting user based on parameters such as age, race, religion, and/or other interests. If there are insufficient members from a particular group, the group may be expanded to cover neighbouring geographical regions as indicated by sub-regions 1001 in FIG. 10 or sub-regions 1100 in FIG. 11.

As described above in connection with FIGS. 10 and 11, is an illustration of an example variable size geographic location model that takes into account inconsistencies in populations that reside in similar-sized regions but, ensures that the flagged item is distributed to similarly-populated regions regardless of region size.

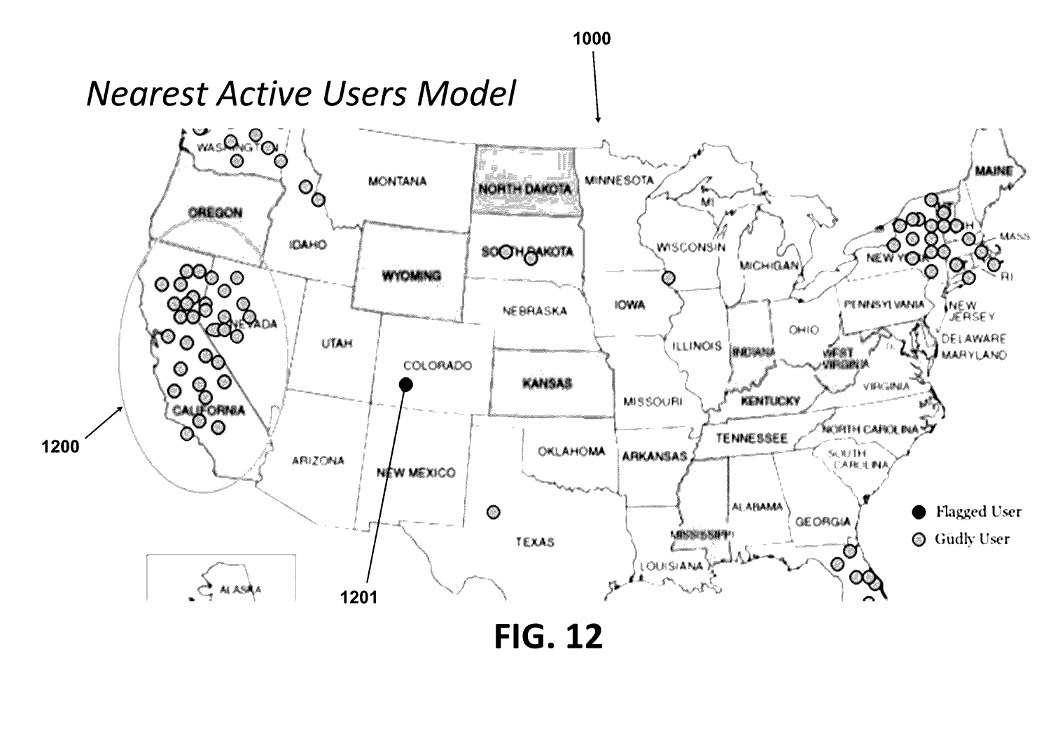

FIG. 12 is a figure of yet another embodiment in which a reviewing team may be based on currently online active users or a nearest active user model. When a post is flagged by a user, the system determines a cluster of online active users in a region 1000 nearest the user posting the content. The user posting the flagged item 1201 in the shown example, resides in Colorado. While there are users of the social networking site that reside throughout the country (with a large population of users for example, in the northeast), the process determines a reviewing team based on the proximity of users or online active users to Colorado 1201, for example, at a given moment. In the shown example, a cluster of users 1200 in closest proximity to the user 1201 is identified in California and Nevada.

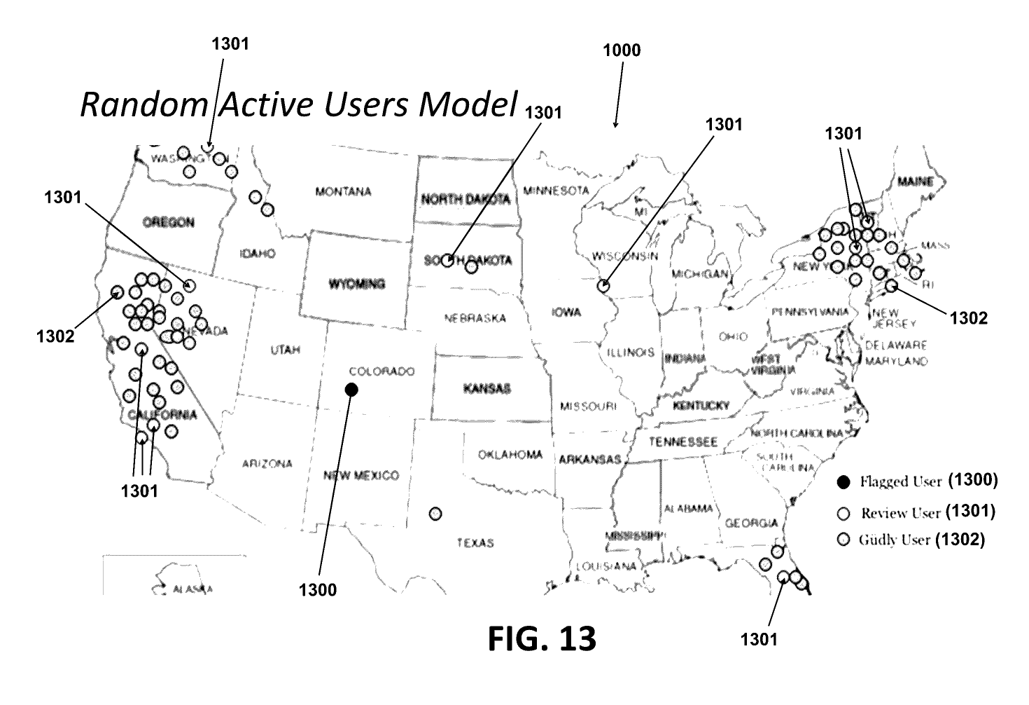

FIG. 13 is a figure of yet another embodiment of random active users and the application of random active user model to identify a reviewing team. When a particular post is flagged 1300 in a region of users 1000, the system determines the cluster of online active users that are near the flagged user but, using the random active user model. The system identifies flag guards or a review team 1301 (as indicated with the lightest shade of grey), by randomly picking from a pool of online active users 1302, (as indicated with the medium shade of grey). For example, if 12 members are required for flagging review, the system distributes the flagged item to 120 members within the Guard arena of clients 101 or users 111. In the shown example, a total of ten review users are identified as shown by designations 1301. A filter may be applied based on previous determined review participation percentages and review success ratios. It is contemplated that the random active user model in certain embodiments further includes the step that when a post is flagged, the system will determine the cluster of online active users in the particular geographic region 1000 or even for example, across the globe. The system can identify a flag guard pool by randomly picking online active users. If G are members required for review or the guard size, P members are chosen as the pool size. G and P are configurable but G is less than or equal to P.

G=members required for review

P=members chosen as pool size

Where, G≦P

There is an additional filter that can be applied to the above ratio, based on a guard ratio. The guard ratio is defined as the percentage of successful guard votes divided by the total of guard votes.

Guard Ratio=% successful Guard votes/total no. Guard votes

The number of guards (including previous determinations may be taken into account), the age group and the locality or region, may also be factored into the above equation for the random active user model determination. In certain embodiments, the actual flagging user and the flagged user are not factored into the Guard review group G.

In yet another contemplated embodiment, the fair share distribution approach may be implemented. Algorithms are implemented to ensure that flagged items are distributed to the best guards identified in the system. For example, if the approaches, as described above in FIGS. 10-13, result in a distribution of more than the required number of users for such a review process, other filtering approaches may be implemented. For example, if the identified cluster includes more than the required numbers which would render a well-reviewed guard outcome (for example, more than 12 members), then the system will filter the distribution list further based on the win/loss ratio of members within the cluster. This system identifies the guards with the best reviewing abilities identified thus far, in the social media networking site and intelligently tailors the process based on an already-identified knowledge base of clusters of users and guards proximate to those regions as identified.

If the identified cluster includes more than the required numbers which generally results in a well-reviewed guard outcome, then filter the distribution list by the users' ratio of participation in previously-distributed flagged items. For example, if a user while participating in the guard process, skips over many items rather than reviews and flags them, then that participant will be weighted with a lower priority when determining the distribution list for a newly flagged item.

If the identified cluster includes more than the required numbers which generally results in a well-reviewed guard outcome, then filter the distribution list by the users' concurrent review of another flagged item. For example, if a user is currently reviewing another item, the system will place a higher precedence on a user who is not currently reviewing the item. This ensures that each flagged item is allowed greater attention and is accordingly given a great weight by a sufficient base of users of the social media network. In certain embodiments, a flag guard participation percentage, a previous flag guard percentage is used to find the best guards. Concurrent guarding in certain embodiments is blocked so that a user not considered as a guard can participate more than once in a predetermined window of time.

Another contemplated embodiment is a flag finalization algorithm which is used to determine the time to stop the voting process on a particular flag. A configurable period of time t is contemplated within which the maximum period of time from the first vote, which may be pre-determined by the system. In addition, a configurable maximum number of votes from the same number of appointed guards, may also be predetermined by the system. The flag finalization algorithm is indicated below as:

t=maximum time period to vote

n=maximum number of votes from guards for x number of guards

where, n=x within a time period of t₁

Final Time for flag finalization=greater oft or t₁

In yet another contemplated embodiment of the flag finalization process, the system will interpret a voting decision based on the majority of votes. If a majority agree on the decision to remove the post or remove the flag from the flagged content and reinstate the content as unflagged content, then the system will render the decision of the majority. If the number is split equally, then the system will render the decision to remove the post. If the number voting in the decision process is insufficient, then no decision will be rendered by the system. In certain contemplated embodiments, a majority rule is not the pre-requisite but rather a quorum which may be less than a majority or even greater than a majority such as a unanimous vote requirement. Any rules for determining the parameters implemented during the flag finalization process, may be predetermined by the system in advance of the voting process in accordance with the contemplated embodiment(s).

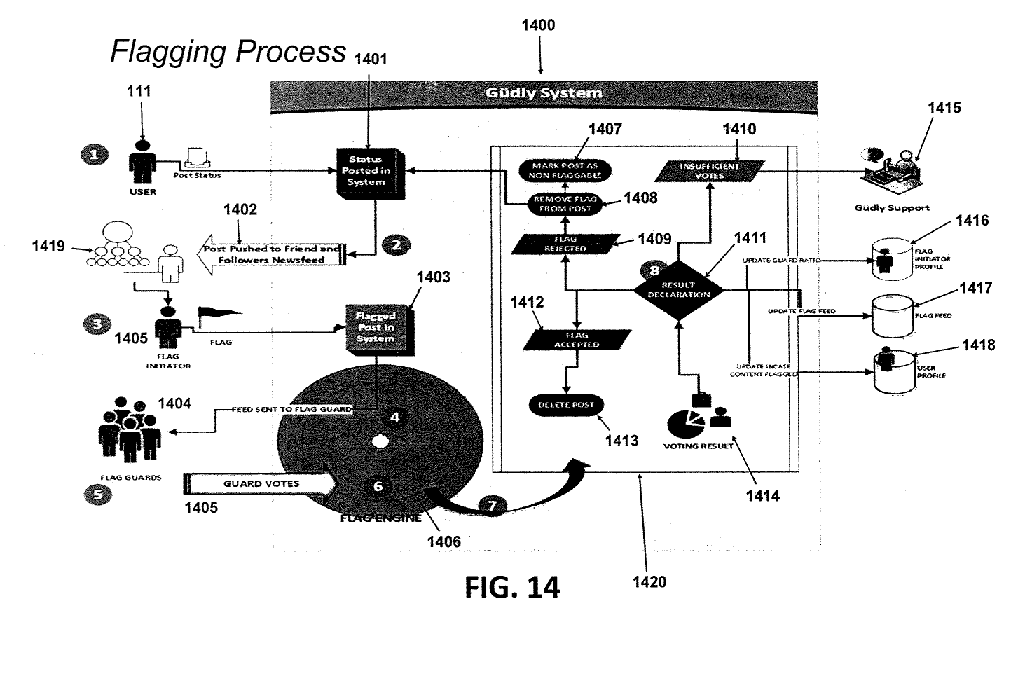

FIG. 14 is exemplary embodiment of the social media networking site. A user 111 may post a comment to the system 1401 which is thereafter posted to a friend and/or followers 1419 in the newsfeed 1402. It is noted that the posting of a comment can occur by a user 111 or may be device specific to the computing device of the client 101. If the posting of a comment is device specific, the administrators of the social networking site are able to trace any user 111 activity to the specific device of the client 101. In certain embodiments, the manufacturer specific identification number of the mobile computing device or other PDA, or similar type of device specific traceable identification code, will prevent fraudulent uses of the user's networking site account and prevent misuse of the above-described guard, voting and flagging processes. The computing device 101's ID can be an identification code that is always associated with the computing device 101 or its network connection. For example, the ID of computing device 101 can be an International Mobile Equipment Identity (IMEI), a Mobile Equipment ID (MEID), an IP address or any other means of tracking and assigning a user to their specific device. Such IDs can be implemented in preventing multiple accounts on the social networking site 105 and additionally, preventing any misuse of the flagging, guard and voting processes of the disclosed embodiments.

As shown in FIG. 14, the flag initiator 1405 may flag content which flagged post is transmitted to the system 1403 using the flag engine or processor 1406 implementing the above-described flagging process. The feed is transmitted to flag guards 1404 which then implement the above-described voting process by generating guard votes 1405 which are in turn transmitted to the flag engine 1406. The flag engine 1406 transmits the data to a flagging unit 1420 which includes the results of the flagging process, whether to mark post as non-flaggable 1407, remove flag from post 1408, reject flag 1409, accept flag 1412 or delete post 1413 as determined by the result declaration unit 1411. The result declaration unit 1411 may be based on voting results 1414 or otherwise, the process may end due to insufficient votes 1410 at which point a support unit 1415 will determine requisite votes required for the voting results to be determined in final. A flag initiator profile database 1416, flag feed database 1417 and user profiles database 1418 may be further updated once the result declaration unit 1411 finalizes the voting process. The flag initiator profile 1416 may be updated with the guard ratio as described hereinabove. The flag feed 1417 may be updated with flag feeds, and the user profiles database 1418 may be further updated with content as additional flagging of content occurs.

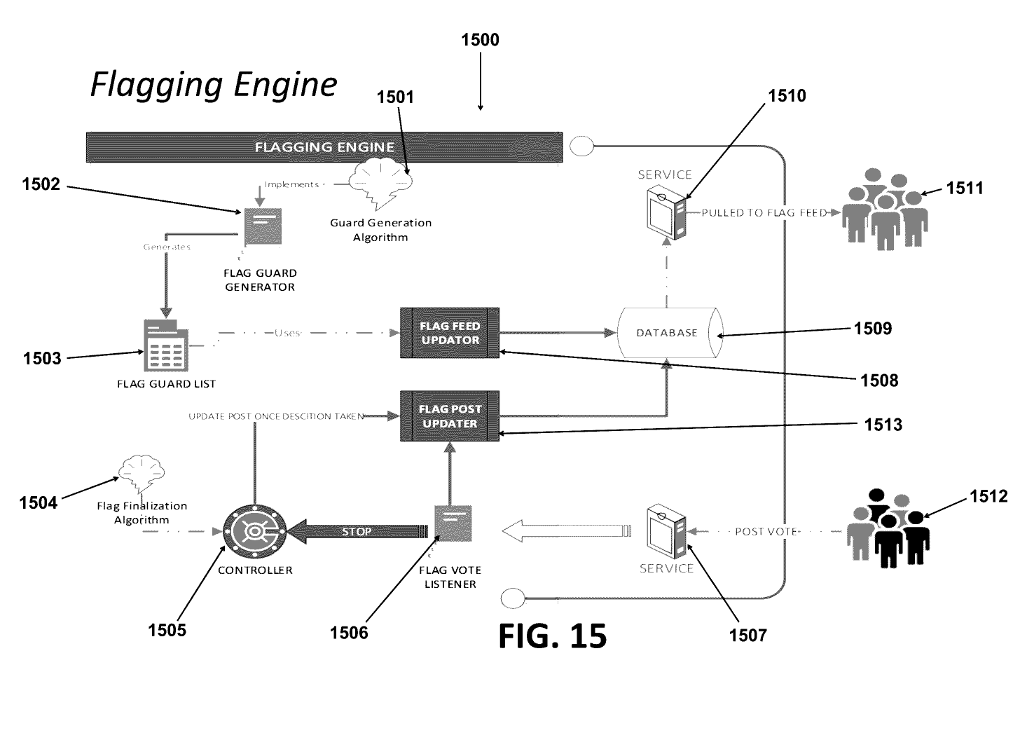

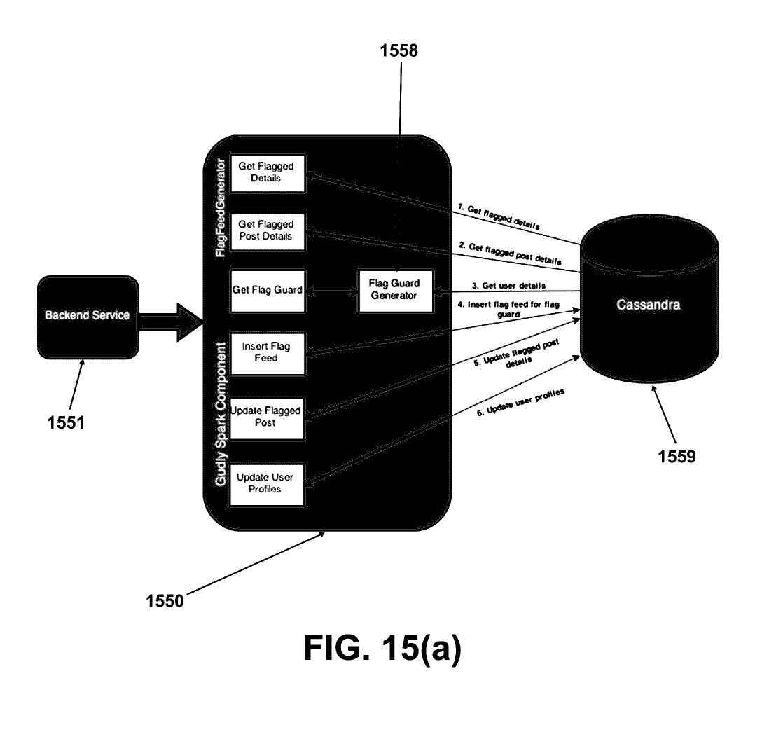

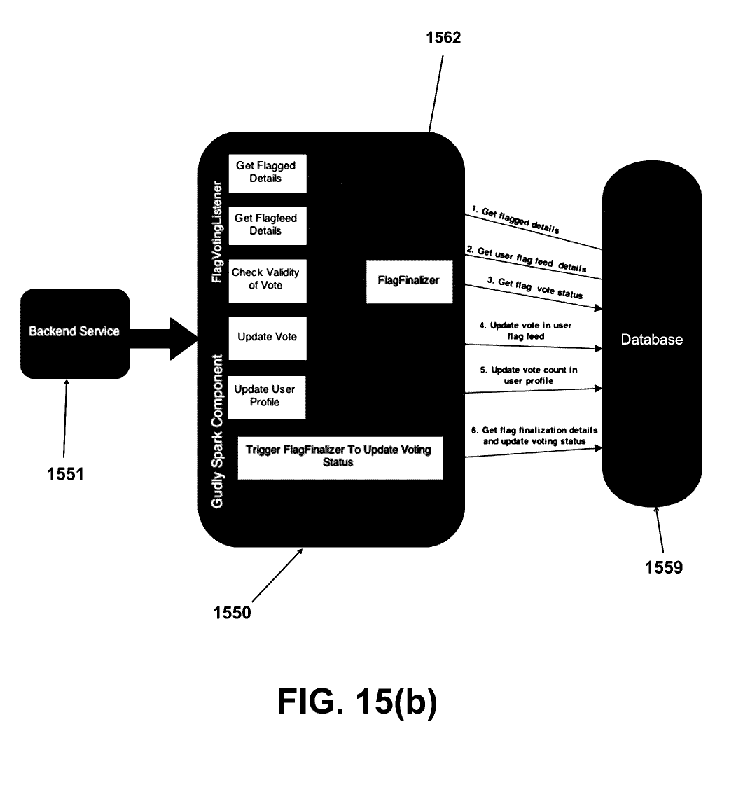

FIG. 15 is an example embodiment of a flagging engine. Various guard generation algorithms 1501 are implemented by the flag guard generator 1502 which creates a flag guard list 1503 of likely guards for the flag voting process. The flag feed updater 1508 monitors and updates the flag feed using a process for example as shown in FIG. 15(a). Once the flag feed is updated, the database 1509 is updated and transmitted to the flag feed process 1511 by a group of users using the service 1510. The flag finalization algorithm 1405 is implemented by a controller 1505 or similar processing device based on the flag vote listener unit 1506. The guards 1512 post votes on the flagged content using a service unit 1507 which is transmitted to the flag vote listener unit 1506. The flag vote listener unit 1506 will receive each of the votes from the flag guard users 1512 and accordingly update the votes in the database 1509 by transmitting updates to the flag post updater 1513. In addition to updating votes, the flag vote listener 1506 will check the validity of the votes, update the vote in the database 1509 assuming determined valid, updates the user counter in the user profile also stored in the database 1509, and will trigger a flag finalizer for updating the flag post updater 1513 when the voting process has ended. The details of the process implemented by flag vote listener unit 1506 is shown and described below, in further detail in connection with FIG. 15(b).

FIG. 15(a) illustrates an embodiment of the process implemented by flag feed generator shown in block 1550 and, additionally of the flag guard generator 1502 as shown and described in connection with FIG. 15. The process associated with the flag guard generator 1558, as shown within block 1550, determines the result of the flagging process as described above, based on the received votes, and accordingly performs updates to the database 1559. The flag guard generator 1558, further determines the result of flagging based on the votes, updates the result in the database 1559, updates post details in the database 1559, and updates the user profile as stored in the database 1559. The backend service 1551 as implemented using a processing device or computing device, monitors the flag feed generator including retrieving flagged details, retrieving flagged post details, and retrieving user profile details. The update component inserts flag feeds, updates flagged posts and updates user profiles by transmitting updates to the database 1559.

FIG. 15 (b) illustrates an embodiment of the flag voting listener unit 1506, as described in connection with FIG. 15. The processing components shown in block 1550 associated with the flag voting listener unit 1506 of FIG. 15, monitor and receive votes from the flag guard, and accordingly update the votes in the database 1559 after checking and determining the validity of such votes, as described above. The backend service 1551, as implemented using a processing device or computing device, monitors the flag voting listener unit 1506, including checking the validity of each vote, updating the vote in the database 1559 if determined valid, updates user vote counts in the user profile database 1559, and further, triggers the flag finalizer 1562, for updating the database 1559 when voting has ended.

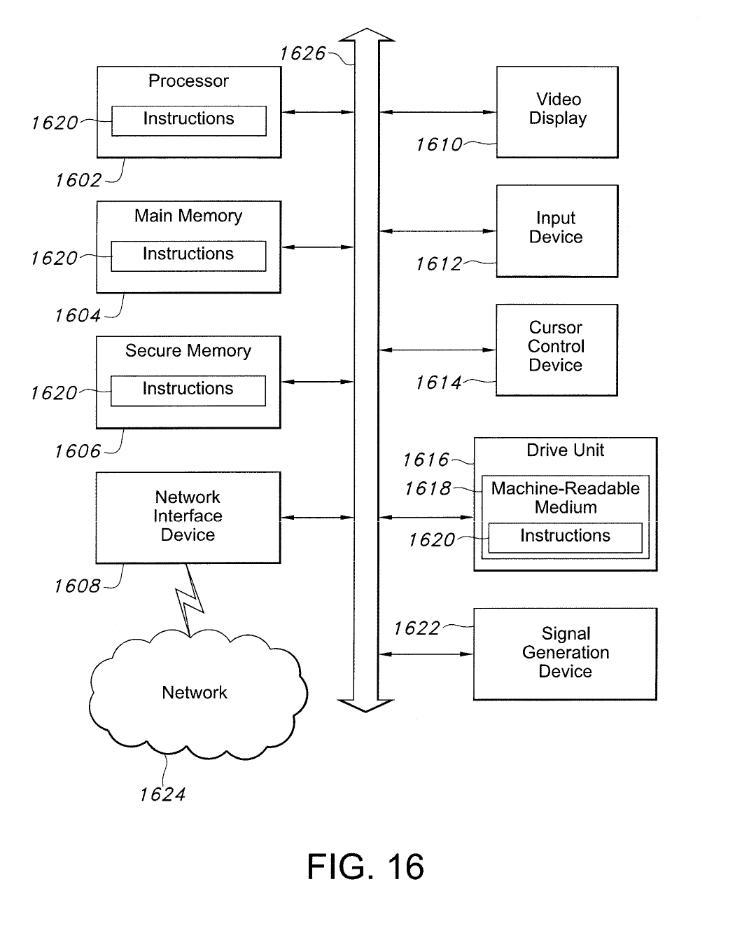

FIG. 16 is a block diagram of an illustrative embodiment of a general computer system 1600. The computer system 1600 can be implemented as or integrated into the computing devices 101, social network server 104, sponsor server 112, and sponsors 110, illustrated of FIG. 1. The computer system 1600 can include a set of instructions 1620 that can be executed to cause the computer system 1600 to perform any one or more of the methods or computer based functions disclosed herein. The computer system 1600, or any portion thereof, may operate as a standalone device or may be connected, e.g., using a network or other connection, to other computer systems or peripheral devices. For example, the computer system 1600 may be connected other systems and device via network 101.

The computer system 1600 may also be implemented as or incorporated into various devices, such as a personal computer (PC), a tablet PC, a personal digital assistant (PDA), a mobile device (e.g., smartphone), a palmtop computer, a laptop computer, a desktop computer, a communications device, a control system, a web appliance, wearable computing device (e.g., bracelet, glasses, broach, etc.) or any other machine capable of executing a set of instructions (sequentially or otherwise) that specify actions to be taken by that machine. Further, while a single computer system 1600 is illustrated, the term “system” shall also be taken to include any collection of systems or sub-systems that individually or jointly execute a set, or multiple sets, of instructions to perform one or more computer functions.

As illustrated in FIG. 16, the computer system 1600 may include a processor 1602, e.g., a central processing module (CPU), a graphics-processing module (GPU), or both. Moreover, the computer system 1600 may include a main memory 1604 and a static memory 1606 that can communicate with each other via a bus 1626. As shown, the computer system 1600 may further include a video display device 1610, such as a liquid crystal display (LCD), an organic light emitting diode (OLED), a flat panel display, a solid state display, or a cathode ray tube (CRT). Additionally, the computer system 1600 may include an input device 1612, such as a keyboard, and a cursor control device 1614, such as a mouse. The computer system 1600 can also include a disk drive device 1616, a signal generation device 1622, such as a speaker or remote control, and a network interface device 1608.

In a particular embodiment or aspect, as depicted in FIG. 16, the disk drive device 1616 may include a computer-readable medium 1618 in which one or more sets of instructions 1620, e.g., software, can be embedded. Further, the instructions 1620 may embody one or more of the methods or logic as described herein. In a particular embodiment or aspect, the instructions 1620 may reside completely, or at least partially, within the main memory 1604, the static memory 1606, and/or within the processing device 1602 during execution by the computer system 1600. The main memory 1604 and the processing device 1602 also may include computer-readable media.

In an alternative embodiment or aspect, dedicated hardware implementations, such as application specific integrated circuits, programmable logic arrays and other hardware devices, can be constructed to implement one or more of the methods described herein. Applications that may include the apparatus and systems of various embodiments or aspects can broadly include a variety of electronic and computer systems. One or more embodiments or aspects described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments or aspects, the methods described herein may be implemented by software programs tangibly embodied in a processor-readable medium and may be executed by a processing device. Further, in an exemplary, non-limited embodiment or aspect, implementations can include distributed processing, component/object distributed processing, and parallel processing. Alternatively, virtual computer system processing can be constructed to implement one or more of the methods or functionality as described herein.

It is also contemplated that a computer-readable medium includes instructions 1620 or receives and executes instructions 1620 responsive to a propagated signal, so that a device connected to a network 1624 can communicate voice, video or data over the network 1624. Further, the instructions 1620 may be transmitted or received over the network 1624 via the network interface device 1608.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processing device or that cause a computer system to perform any one or more of the methods or operations disclosed herein.

In a particular non-limiting, example embodiment or aspect, the computer-readable medium can include a solid-state memory, such as a memory card or other package, which houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals, such as a signal communicated over a transmission medium. A digital file attachment to an e-mail or other self-contained information archive or set of archives may be considered a distribution medium that is equivalent to a tangible storage medium. Accordingly, any one or more of a computer-readable medium or a distribution medium and other equivalents and successor media, in which data or instructions may be stored, are included herein.

In accordance with various embodiments or aspects, the methods described herein may be implemented as one or more software programs running on a computer processing device. Dedicated hardware implementations including, but not limited to, application specific integrated circuits, programmable logic arrays, and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, a tangible storage medium or distribution medium as listed herein, and other equivalents and successor media, in which the software implementations herein may be stored, are included herein.

Although the present specification describes components and functions implemented in the embodiments with reference to particular standards and protocols, the disclosed embodiment are not limited to such standards and protocols.

In accordance with various embodiments, the methods, functions or logic described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods, functions or logic described herein.

Such embodiments of the inventive subject matter may be referred to herein, individually and/or collectively, by the term “embodiment” merely for convenience and without intending to voluntarily limit the scope of this application to any single embodiment or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The Abstract is provided to comply with 31 C.F.R. §1.12(b), which requires an abstract that will allow the reader to quickly ascertain the nature of the technical disclosure. It is submitted with the understanding that it will not be used to interpret or limit the scope or meaning of the claims.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

Although preferred embodiments have been described herein with reference to the accompanying drawings, it is to be understood that the disclosure is not limited to those precise embodiments and that various other changes and modifications may be affected herein by one skilled in the art without departing from the scope or spirit of the embodiments, and that it is intended to claim all such changes and modifications that fall within the scope of this disclosure.

1. A system for facilitating integrity based communications among users of a social network, the system comprising:
at least one processing device; and
a server that interfaces with the at least one processing device which performs operations comprising:
receiving a first message on the social network from a first user that is available to second users of the social network;
transmitting an indication, the indication being displayed on a visual representation associated with the social network, the indication available to second users of the social network and specifying that the first message is flagged by a third user as non-compliant with a policy of the social network;
transmitting the first message for a review by a first voter selected from a plurality of users of the social network, the first voter is selected based on a predetermined model, wherein the review determines if the first message will be removed from the social networking site;
transmitting a result of the review to the first user, wherein the result of the review determining if the first user is restricted from posting the first message for a predetermined period of time; and
determining if the review by the at least one voter is ratified by a quorum of users above a threshold value.

2. The system according to claim 1, wherein the result of the review further comprises determining if the first user is banned from the social network site.

3. The system according to claim 1, wherein the visual representation associated with the network includes a first menu of selection items.

4. The system according to claim 3, wherein the visual representation further includes a second menu of selection items.

5. The system according to claim 4, wherein the second menu of selection items is subordinate to the first menu of selection items.

6. The system according to claim 1, wherein the result of the review, further includes a decision to reactivate at least one of a share, like, and comment feature.

7. The system according to claim 1, wherein the result of the review further includes the removal of the first message from the social network.

8. The system according to claim 1, wherein the result of the review further includes reinstating the first message.

9. The system according to claim 8, wherein the result of the review further includes disabling the post from being further flagged.

10. The system according to claim 1 wherein the result of the review further includes transmitting a message to the first user of the decision.

11. The system according to claim 10, wherein the decision of the review further includes suspending the user for a pre-determined period of time.

12. The system according to claim 10, wherein the decision of the review further includes transmitting a banned notification to the first user.

13. The system according to claim 1, wherein the predetermined model is based on one of a geographical location of users, cluster of online active users in a region nearest the first user, random active users and users with a well-reviewed outcome.

14. The system according to claim 1, wherein the review further comprises a guard decision by a plurality of voters.

15. A computer-readable device storing instructions that, when executed by a computing device, cause the computing device to perform operations that comprise:
receiving a first message on the social network from a first user that is available to second users of the social network;
transmitting an indication, the indication being displayed on a visual representation associated with the social network, the indication available to second users of the social network and specifying that the first message is flagged by a third user as non-compliant with a policy of the social network;
transmitting the first message for a review by a first voter selected from a plurality of users of the social network, the first voter is selected based on a predetermined model, wherein the review determines if the first message will be removed from the social networking site;
transmitting a result of the review to the first user, wherein the result of the review determining if the first user is restricted from posting the first message for a predetermined period of time; and
determining if the review by the at least one voter is ratified by a quorum of users above a threshold value.

16. A social network comprising:
at least one processing device; and
a memory to store instructions that, when executed by the processing device, perform operations comprising:
providing a social network to facilitate communication between a plurality of users of the social network operating respective computing devices that are registered for operating to send messages using the social network, the communication including submitting a message by a first user of the plurality of users for access or receipt by a second user of the plurality of users;
registering the respective computing devices to send messages using the social network, including associating an identification number of the respective computing devices with respective registrations of the computing device;
flagging a message for inappropriate social network behavior;
submitting the flagged message for review by at least one arbitrator user selected from the plurality of users for a determination of inappropriateness of the message; and
applying restrictions to participation by the first user in the social network in response to a determination associated with the review by the at least one arbitrator that the message is inappropriate.

17. The social network according to claim 16, wherein applying the restrictions further includes displaying an indicator associated with a displayed profile associated with the first user when the first user participates in the social network, the indicator indicating that a penalty was determined for the first user.

18. The social network according to claim 16, wherein the penalty is one of probation for a selected time period, suspension of participation in the social network for a selected time period, and expulsion from the social network.

19. The social network according to claim 18, wherein the suspension and expulsion further include blocking access to the social network by the first user's computing device based on the identification number associated with the registration of the computing device.

20. A social network comprising:
at least one processing device; and
a server that communicates with the at least one processing device that performs operations comprising:
providing a social network to facilitate communication between a plurality of users of the social network operating respective computing devices to send messages using the social network, in which a message is communicated by a first user of the plurality of users for access or receipt by a second user of the plurality of users;
flagging a message for demonstrating positive social network behavior;
submitting the flagged message for a determination that the message demonstrates positive social network behavior;
rewarding the first user by awarding points to the first user in response to a determination that the message demonstrates positive social network behavior;
receiving a schedule of points and deeds from a device of a sponsor participant in the social network that describes a payment scheme relating at least one deed to a value of points; and
receiving from the first user a payment of points having a value in exchange for a commitment by the sponsor participant to perform a deed that is related to the value in accordance with the schedule of points and deeds.
